(19) United States
(12) Patent Application Publication
(10) Pub. No.: US 2023/0389019 A1
(43) Pub. Date: Nov. 30, 2023

(54) METHOD AND APPARATUS FOR BEAM INDICATION IN A WIRELESS COMMUNICATION SYSTEM

(71) Applicant: ASUS Technology Licensing Inc., Taipei City (TW)

(72) Inventor: CHUN-WEI HUANG, Taipei City (TW)

(21) Appl. No.: 18/202,344

(22) Filed: May 26, 2023

Related U.S. Application Data
(60) Provisional application No. 63/346,694, filed on May 27, 2022.

(51) Int. Cl. H04W 72/1273

(52) U.S. Cl. CPC H04W 72/1273

(57) ABSTRACT

In an example, a User Equipment (UE) receives a first Physical Downlink Control Channel (PDCCH) indicating a first Transmission Configuration Indicator (TCI) state and a second TCI state. The first TCI state and/or the second TCI state are configured to be applied for one or more receptions. The UE receives a second PDCCH. When a scheduling offset between the second PDCCH and a scheduled DL reception is smaller than a threshold, the UE determines a third TCI state to use for the scheduled DL reception based on whether or not a first reference signal (RS) associated with the first TCI state is associated with a serving cell of the UE and/or whether or not a second RS associated with the second TCI state is associated with the serving cell. The UE receives and/or buffers the scheduled DL reception based on one or more TCI states including the third TCI state.

### CROSS-REFERENCE TO RELATED APPLICATIONS

The present Application claims the benefit of U.S. Provisional Patent Application Ser. No. 63/346,694 filed on May 27, 2022, the entire disclosure of which is incorporated herein in its entirety by reference.

### FIELD

This disclosure generally relates to wireless communication networks, and more particularly, to a method and apparatus for beam indication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE), the UE receives a first Physical Downlink Control Channel (PDCCH) indicating a first Transmission Configuration Indicator (TCI) state comprising a first downlink (DL) TCI state and/or a first joint TCI state, and a second TCI state comprising a second DL TCI state and/or a second joint TCI state, wherein the first TCI state and/or the second TCI state are configured to be applied for one or more receptions comprising one or more UE-dedicated DL receptions after a first time. The UE receives a second PDCCH. When a scheduling offset between the second PDCCH and a scheduled DL reception is smaller than a threshold, the UE determines a third TCI state to use for the scheduled DL reception based on whether or not a first reference signal (RS) associated with the first TCI state is associated with a serving cell of the UE and/or whether or not a second RS associated with the second TCI state is associated with the serving cell. The UE receives and/or buffers the scheduled DL reception based on one or more TCI states comprising the third TCI state.

In an example from the perspective of a UE, the UE receives a first PDCCH indicating a first TCI state comprising a first DL TCI state and/or a first joint TCI state, and a second TCI state comprising a second DL TCI state and/or a second joint TCI state, wherein the first TCI state and/or the second TCI state are configured to be applied for one or more receptions comprising one or more UE-dedicated DL receptions after a first time. The UE receives a second PDCCH. When a scheduling offset between the second PDCCH and a scheduled DL reception is smaller than a threshold, the UE determines a third TCI state to use for the scheduled PDSCH based on the first TCI state. A first RS associated with the first TCI state is associated with a serving cell. A second RS associated with the second TCI state is associated with the serving cell. A TCI codepoint is indicative of a first octet index associated with the first TCI state and a second octet index associated with the second TCI state. The first octet index is lower than the second octet index. The UE receives and/or buffers the scheduled DL reception based on one or more TCI states comprising the third TCI state.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 illustrates a unified Transmission Configuration Indicator (TCI) state activation and/or deactivation Medium Access Control (MAC) Control Element (CE) according to one exemplary embodiment.

FIG. 6 illustrates an enhanced TCI State activation and/or deactivation for a UE-specific Physical Downlink Shared Channel (PDSCH) MAC CE according to one exemplary embodiment.

FIG. 7 illustrates an enhanced TCI State activation and/or deactivation for a UE-specific PDSCH MAC CE according to one exemplary embodiment.

FIG. 8 illustrates a data structure and/or a timing diagram associated with an example scenario according to one exemplary embodiment.

FIG. 9 illustrates a data structure and/or a timing diagram associated with an example scenario according to one exemplary embodiment.

FIG. 10 illustrates a data structure associated with an example scenario according to one exemplary embodiment.

FIG. 11 illustrates a data structure associated with an example scenario according to one exemplary embodiment.

FIG. 12 illustrates a timing diagram associated with an example scenario according to one exemplary embodiment.

FIG. 13 illustrates a data structure associated with an example scenario according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

FIG. 18 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: 3GPP TS 38.213, V17.1.0; 3GPP TS 38.214, V17.1.0; 3GPP TS 38.331, V17.0.0; 3GPP TS 38.212, V17.1.0; 3GPP TS 38.321, V17.0.0. The standards and documents listed above are hereby expressly incorporated by reference in their entirety.

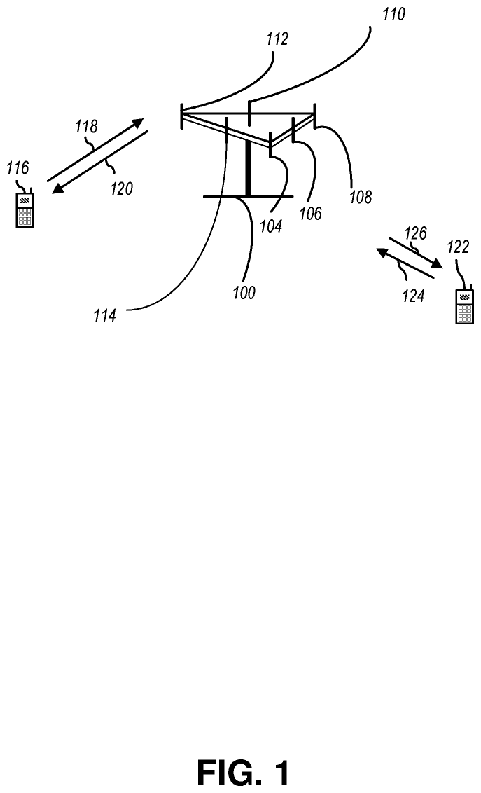

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

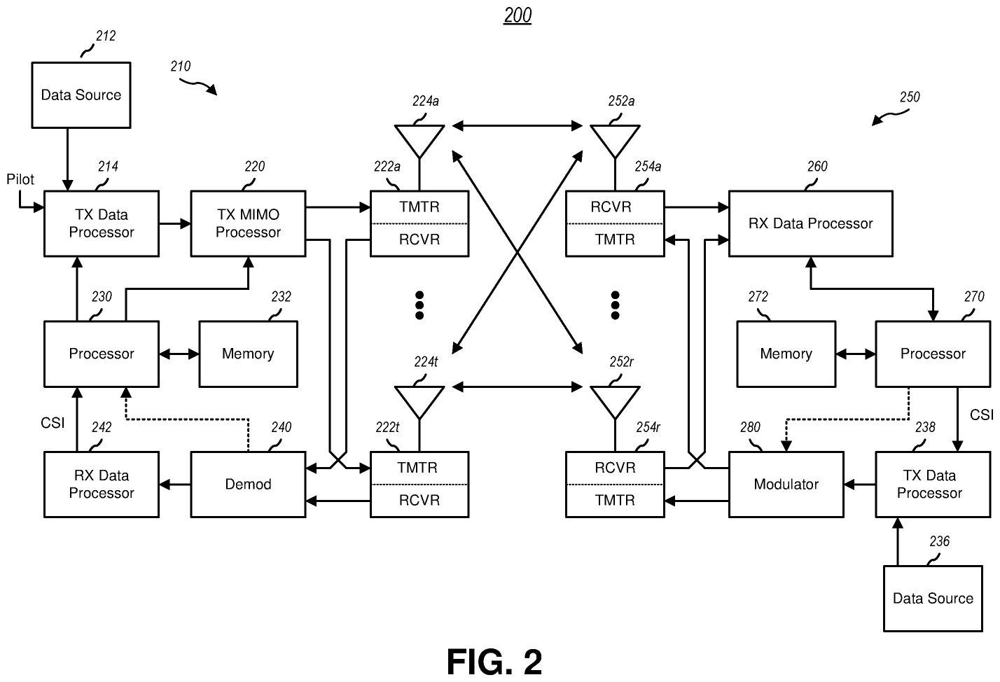

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

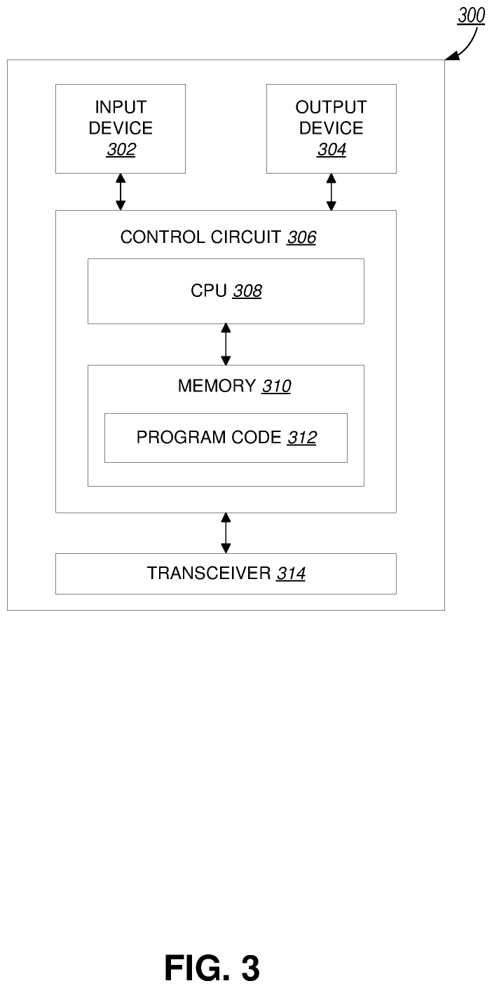

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

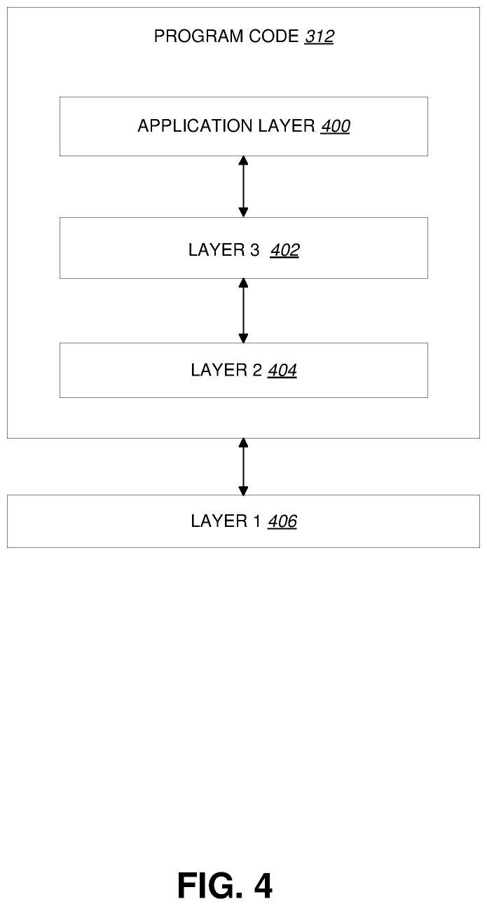

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

3GPP TS 38.213, V17.1.0 Discusses Unified Transmission Configuration Indicator (TCI) framework related paragraph. One or more parts of 3GPP TS 38.213, V17.1.0 are quoted below:

10.1 UE procedure for determining physical downlink control channel assignment

A set of PDCCH candidates for a UE to monitor is defined in terms of PDCCH search space sets. A search space set can be a CSS set or a USS set. A UE monitors PDCCH candidates in one or more of the following search spaces sets
a Type0-PDCCH CSS set on the primary cell of the MCG configured by
   pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, or
   searchSpaceZero in PDCCH-ConfigCommon when pdcch-Config-MCCH and pdcch-Config-MTCH are not provided, for a DCI format 4_0 with CRC scrambled by a MCCH-RNTI or a G-RNTI
Type0A-PDCCH CSS set configured by searchSpaceOtherSystemInformation in PDCCH-ConfigCommon for a DCI format 1_0 with CRC scrambled by a SI-RNTI on the primary cell of the MCG
. . .
a Type1-PDCCH CSS set configured by ra-SearchSpace in PDCCH-ConfigCommon for a DCI format 1_0 with CRC scrambled by a RA-RNTI, a MsgB-RNTI, or a TC-RNTI on the primary cell
. . .
. . .
a Type3-PDCCH CSS set configured by
   SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI, or
   . . .
a USS set configured by
   SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL Semi-Persistent Scheduling V-RNTI, or
   . . .
. . .

For each DL BWP configured to a UE in a serving cell, the UE can be provided by higher layer signalling with
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControiResourceSet:
a CORESET index p, by controlResourceSead or by controlResourceSetId-v1610, where
   0<p<12 if coresetPoolIndex is not provided, or if a value of coresetPoolIndex is same for all CORESETs if coresetPoolIndex is provided;
   0<p<16 if coresetPoolIndex is not provided for a first CORESET, or is provided and has a value 0 for a first CORESET, and is provided and has a value 1 for a second CORESET;
. . .

For a CORESET with index 0,
if the UE is provided DLorJoint-TCIState and iffollowUnifiedTCIstate=‘enabled’ for the CORESET, the UE assumes that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the indicated DLorJoint-TCIState [6, TS 38.214]
else, the UE assumes that a DM-RS antenna port for PDCCH receptions in the CORESET is quasi co-located with
   the one or more DL RS configured by a TCI state, where the TCI state is indicated by a MAC CE activation command for the CORESET, if any, or
   a SS/PBCH block the UE identified during a most recent random access procedure not initiated by a PDCCH order that triggers a contention-free random access procedure, if no MAC CE activation command indicating a TCI state for the CORESET is received after the most recent random access procedure, or a SS/PBCH block the UE identified during a most recent configured grant PUSCH transmission as described in clause 19.
. . .

If a UE is provided DLorJoint-TCIState, a DM-RS antenna port for PDCCH receptions in a CORESET, other than a CORESET with index 0, associated only with USS sets and/or Type3-PDCCH CSS sets, and a DM-RS antenna port for PDSCH receptions scheduled by DCI formats provided by PDCCH receptions in the CORESET are quasi co-located with reference signals provided by the indicated DLorJoint-TCIState [6, TS 38.214].

If a UE is provided followUnifiedTCIstate for a CORESET, other than a CORESET with index 0, associated at least with CSS sets other than Type3-PDCCH CSS sets, and iffollowUnifiedTCIstate is set as enabled, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated DLorJoint-TCIState.

3GPP TS 38.214, V17.1.0 discusses beam indication. One or more parts of 3GPP TS 38.214, V17.1.0 are quoted below:

### 5.1 UE Procedure for Receiving the Physical Downlink Shared Channel

When a UE is configured by the higher layer parameter repetitionNumber in PDSCH-TimeDomainResourceAllocation, the UE may expect to be indicated with one or two TCI states in a codepoint of the DCI field ‘Transmission Configuration Indication’ together with the DCI field ‘Time domain resource assignment’ indicating an entry which contains repetitionNumber in PDSCH-TimeDomainResourceAllocation and DM-RS port(s) within one CDM group in the DCI field ‘Antenna Port(s)’.
When two TCI states are indicated in a DCI with ‘Transmission Configuration Indication’ field, the UE may expect to receive multiple slot level PDSCH transmission occasions of the same TB with two TCI states used across multiple PDSCH transmission occasions in the repetitionNumber consecutive slots as defined in Clause 5.1.2.1.
When one TCI state is indicated in a DCI with ‘Transmission Configuration Indication’ field, the UE may expect to receive multiple slot level PDSCH transmission occasions of the same TB with one TCI state used across multiple PDSCH transmission occasions in the repetitionNumber consecutive slots as defined in Clause 5.1.2.1.

When a UE is not indicated with a DCI that DCI field ‘Time domain resource assignment’ indicating an entry which contains repetitionNumber in PDSCH-TimeDomainResourceAllocation, and it is indicated with two TCI states in a codepoint of the DCI field ‘Transmission Configuration Indication’ and DM-RS port(s) within two CDM groups in the DCI field ‘Antenna Port(s)’ and it is not configured with higher layer parameter sfnSchemePdsch, the UE may expect to receive a single PDSCH where the association between the DM-RS ports and the TCI states are as defined in Clause 5.1.6.2.

When a UE is not indicated with a DCI that DCI field ‘Time domain resource assignment’ indicating an entry which contains repetitionNumber in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause 5.1.

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTClstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: { Doppler shift, average delay }
‘typeD’: {Spatial Rx parameter}

The UE can be configured with a list of up to 128 DLorfointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining UL TX spatial filter for dynamic-grant and configured-grant based PUSCH and PUCCH resource in a CC, and SRS.

If the DLorfointTCIState or UL-TCIState configurations are absent in a BWP of the CC, the UE can apply the DLorfointTCIState or UL-TCIState configurations from a reference BWP of a reference CC. The UE is not expected to be configured with TCI-State, SpatialRelationlnfo or PUCCH-SpatialRelationlnfo, except SpatialRelationlnfoPos in a CC in a band, if the UE is configured with DLorfointTCIState or UL-TCIState in any CC in the same band. The UE can assume that when the UE is configured with TCI-State in any CC in the CC list configured by simultaneousTCI-UpdateListl-r16, simultaneousTCI-UpdateList2-r16, simultaneousSpatial-UpdatedListl-r16, or simultaneousSpatial-UpdatedList2-r16, the UE is not configured with DLorJointTCIState or UL-TCIState in any CC within the same band in the CC list.

The UE receives an activation command, as described in clause 6.1.3.14 of [10, TS 38.321] or 6.1.3.x of [10, TS 38.321], used to map up to 8 TCI states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

When the bwp-id or cell for QCL-TypeA/D source RS in a QCL-Info of the TCI state configured with DLorJointTCIState is not configured, the UE assumes that QCL-TypeA/D source RS is configured in the CC/DL BWP where TCI state applies.

When tci-PresentlnDC1 is set as ‘enabled’ or tci-PresentDCI-1-2 is configured for the CORESET, the UE with activated DLorJointTCIState or UL-TCIState receives DCI format 1_1/1_2 providing indicated DLorJointTCIState or UL-TCIState for a CC or all CCs in the same CC list configured by simultaneousTCI-UpdateList1-r17, simultaneousTCI-UpdateList2-r17, simultaneousTCI-UpdateList3-r17, simultaneousTCl-UpdateList4-r17. The DCI format 1_1/1_2 can be with or without, if applicable, DL assignment. If the DCI format 1_1/1_2/ is without DL assignment, the UE can assume the following:
CS-RNTI is used to scramble the CRC for the DCI
The values of the following DCI fields are set as follows:
   RV=all ‘1’s
   MCS=all ‘1’s
   NDI=0
   Set to all ‘0’s for FDRA Type 0, or all ‘1’sfor FDRA Type 1, or all ‘0’s for dynamicSwitch (same as in Table 10.2-4 of [6, TS 38.213]).

. . . . If a UE receives a higher layer configuration of a single DLorJoint-TCIState, that can be used as an indicated TCI state, the UE obtains the QCL assumptions from the configured TCI state for DM-RS of PDSCH and DM-RS of PDCCH, and the CSI-RS applying the indicated TCI state.

. . . . When the UE would transmit the last symbol of a PUCCH with HARQ-ACK information corresponding to the DCI carrying the TCI State indication and without DL assignment, or corresponding to the PDSCH scheduling by the DCI carrying the TCI State indication, and if the indicated TCI State is different from the previously indicated one, the indicated DLorfointTClState or UL-TCIstate should be applied starting from the first slot that is at least BeamAppTime_r17 symbols after the last symbol of the PUCCH. The first slot and the BeamAppTime_r17 symbols are both determined on the carrier with the smallest SCS among the carrier(s) applying the beam indication.

If the UE is configured with [NumberOfAdditionalPCI] and with PDCCH-Config that contains two different values of coresetPoolIndex in ControiResourceSet, the UE receives an activation command for CORESET associated with each coresetPoolIndex, as described in clause 6.1.3.14 of [10, TS 38.321], used to map up to 8 TCI states to the codepoints of the DCI field ‘Transmission Configuration Indication’ in one CC/DL BWP. When a set of TCI state IDs are activated for a coresetPoolIndex, the activated TCI states corresponding to one coresetPoolIndex can be associated with one physical cell ID and activated TCI states corresponding to another coresetPoolIndex can be associated with another physical cell ID.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot
. . .

$$n + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH and μ_{K}_{_{mac}} is the subcarrier spacing configuration for k mac with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [13, TS 38.306]. For a single slot PDSCH, the indicated TCI state(s) should be based on the activated TCI states in the slot with the scheduled PDSCH . . . . .

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSead in the latest slot in which one or more CORESETs within the active BWP of the serving cell are monitored by the UE . . . .
If a UE is configured with enableDefaultTCI-StatePerCoresetPoolIndex and the UE is configured by higher layer parameter PDCCH-Config that contains two different values of coresetPoolIndex in different ControiResourceSets,
   the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSead among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE . . . . .
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion . . . .

For the DM-RS of PDSCH, the UE shall expect that a TCI-State or DLorJointTCIState except an indicated DLorJointTCIState indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition,or
typeA' with a CSI-RS resource in a NZP-CSI-RS-ResourceSet configured without higher layer parameter trs-Info and without higher layer parameter repetition and, when applicable, ‘typeD’ with the same CSI-RS resource.

3GPP TS 38.331, V17.0.0 discusses information element related to unified TCI and power control. One or more parts of 3GPP TS 38.331, V17.0.0 are quoted below:

### ControlResourceSet

The IE ControlResourceSet is used to configure a time/frequency control resource set (CORESET) in which to search for downlink control information (see TS 38.213 [13], clause 10.1).

ControlResourceSet information element

| -- ASN1START | |
|---|---|
| -- TAG-CONTROLRESOURCESET-START | |
| ControlResourceSet ::= | SEQUENCE { |
| controlResourceSetId | ControlResourceSetId, |
| duration | INTEGER |
| (1..maxCoReSetDuration), | |
| tci-PresentInDCI | ENUMERATED {enabled} |
| OPTIONAL, -- Need S | |
| coresetPoolIndex-r16 | INTEGER (0..1) |
| OPTIONAL, -- Need S | |
| controlResourceSetId-v1610 | ControlResourceSetId-v1610 |
| OPTIONAL -- Need S | |
| ]], | |
| [[ | |
| followUnifiedTCIstate-r17 | ENUMERATED {enabled} |
| OPTIONAL -- Need R | |
| ]] | |
| } | |

ControlResourceSet field descriptions

coresetPoolIndex
The index of the CORESET pool for this CORESET as specified in TS 38.213 [13] (clauses 9
and 10) and TS 38.214 [19] (clauses 5.1 and 6.1). If the field is absent, the UE applies the
value 0.
duration
Contiguous time duration of the CORESET in number of symbols (see TS 38.211 [16], clause
7.3.2.2).
followUnifiedTCIstate
When set to enabled, for PDCCH reception on this CORESET, the UE applies the “indicated”
Rel-17 DL only or joint TCI as specified in TS 38.214 clause 5.1.5.
tci-PresentInDCI
This field indicates if TCI field is present or absent in DCI format 1_1. When the field is absent
the UE considers the TCI to be absent/disabled. In case of cross carrier scheduling, the
network sets this field to enabled for the ControlResourceSet used for cross carrier
scheduling in DCI format 1_1 in the scheduling cell if enableDefaultBeamForCCS is not
configured (see TS 38.214 [19], clause 5.1.5).

### PCI-List

The IE PCI-List concerns a list of physical cell identities, which may be used for different purposes.

PCI-List information element

-- ASN1START
-- TAG-PCI-LIST-START
PCI-List ::= SEQUENCE (SIZE
(1..maxNrofCellMeas)) OF PhysCellId
-- TAG-PCI-LIST-STOP
-- ASN1STOP

### PhysCellId

The PhysCellid identifies the physical cell identity (PCI).

PhysCellId information element

-- ASN1START
-- TAG-PHYSCELLID-START
PhysCellId ::= INTEGER (0..1007)
-- TAG-PHYSCELLID-STOP
-- ASN1STOP

PDSCH-Config The PDSCH-Config IE is used to configure the UE specific PDSCH parameters.

```
  beamAppTime-r17 ENUMERATED {n1, n2,
n4, n7, n14, n28, n42, n56, n70, n84, n98, n112, n224, n336, spare2,
                                                spare1}
OPTIONAL, -- Need R
```

beamApp Time

Indicates the first slot to apply the unified TCI indicated by DCI as specified in TS 38.214
Clause 5.1.5. The value n1 means 1 symbol, n2 two symbols and so on. The first slot is at
least Y symbols indicated by beamAppTime parameter after the last symbol of the
acknowledgment of the joint or separate DL/UL beam indication. The same value shall be
configured for all serving cells in any one of the simultaneousU-TCI-UpdateListN configured
in IE CellGroupConfig based on the smallest SCS of the active BWP.

### PDSCH-TimeDomainResourceAllocationList

The IE PDSCH-TimeDomainResourceAllocation is used to configure a time domain relation between PDCCH and PDSCH

PDSCH-TimeDomainResourceAllocationList information element

-- ASN1START
-- TAG-PDSCH-TIMEDOMAINRESOURCEALLOCATIONLIST-START
PDSCH-TimeDomainResourceAllocationList-r16 ::= SEQUENCE
(SIZE (1..maxNrofDL-Allocations)) OF PDSCH-
TimeDomainResourceAllocation-r16
PDSCH-TimeDomainResourceAllocation-r16 ::= SEQUENCE {

| | |
|---|---|
| k0-r16 | INTEGER (0..32) |

OPTIONAL, -- Need S

| | |
|---|---|
| mappingType-r16 | ENUMERATED {typeA, |
| typeB}, | |
| startSymbolAndLength-r16 | INTEGER (0..127), |
| repetitionNumber-r16 | ENUMERATED {n2, n3, n4, |
| n5, n6, n7, n8, n16} | OPTIONAL, -- Cond Formats1- |
| 0and1-1 | |

...
}
-- TAG-PDSCH-TIMEDOMAINRESOURCEALLOCATIONLIST-STOP
-- ASN1STOP

PDSCH-TimeDomainResourceAllocation field descriptions

k0
Slot offset between DCI and its scheduled PDSCH (see TS 38.214 [19], clause 5.1.2.1). For
k0-r17, only values {0 . . . 32} are applicable for PDSCH SCS of 120 KHz. When the field is
absent the UE applies the value 0.
mapping Type
PDSCH mapping type (see TS 38.214 [19], clause 5.3).
repetitionNumber
Indicates the number of PDSCH transmission occasions for slot-based repetition scheme in
IE RepetitionSchemeConfig. The parameter is used as specified in 38.214 [19]. This field is
not present when PDSCH-TimeDomainResourceAllocation-r16 is included in SIB20.
startSymbolAndLength
An index giving valid combinations of start symbol and length (jointly encoded) as start and
length indicator (SLIV). The network configures the field so that the allocation does not cross
the slot boundary (see TS 38.214 [19], clause 5.1.2.1).

[symbol]

[symbol]

[symbol]

[symbol]

[symbol]

[symbol]

[symbol]

indicates data missing or illegible when filed

### SSB-MTC

The IE SSB-MTC is used to configure measurement timing configurations, i.e., timing occasions at which the UE measures SSBs.

SSB-MTC information element

-- ASN1START
-- TAG-SSB-MTC-START
...

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |

### SearchSpace

The IE SearchSpace defines how/where to search for PDCCH candidates. Each search space is associated with one ControlResourceSet.

SearchSpace field descriptions

controlResourceSetId
The CORESET applicable for this SearchSpace. Value 0 identifies the common CORESET#0
configured in MIB and in ServingCellConfigCommon. Values
1 . . . maxNrofControlResourceSets-1 identify CORESETs configured in System Information or
by dedicated signalling. The CORESETs with non-zero controlResourceSetld are configured
in the same BWP as this SearchSpace except commonControlResourceSetExt which is
configured by SIB20.
searchSpaceId
Identity of the search space. SearchSpaceld = 0 identifies the searchSpaceZero configured
via PBCH (MIB) or ServingCellConfigCommon and may hence not be used in the
SearchSpace IE. The searchSpaceld is unique among the BWPs of a Serving Cell.
searchSpaceType
Indicates whether this is a common search space (present) or a UE specific search space as
well as DCI formats to monitor for.

### TCI-State

The IE TCI-State associates one or two DL reference signals with a corresponding quasi-colocation (QCL) type. If additionalPCI is configured for the reference signal, same value is configured for both DL reference signals.

TCI-State information element

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |
| }, | |
| qcl-Type | ENUMERATED {typeA, typeB, |
| typeC, typeD}, | |
| ..., | |
| [[ | |
| additionalPCI-r17 | AdditionalPCIIndex-r17 |

OPTIONAL -- Need R

| | |
|---|---|
| } | |
| DLorJoint-TCIState-r17 ::= | SEQUENCE { |
| tci-StateUnifiedId-r17 | TCI-StateId, |
| qcl-Type1-r17 | QCL-Info-r17, |
| qcl-Type2-r17 | QCL-Info-r17 |

OPTIONAL, -- Need R

| | |
|---|---|
| ul-powerControl-r17 | Uplink-powerControlId- |
| r17 | OPTIONAL, -- |
| Need R | |
| pathlossReferenceRS-Id-r17 | PUSCH- |
| PathlossReferenceRS-Id -r17 | |
| OPTIONAL -- Need S | |
| } | |
| -- TAG-TCI-STATE-STOP | |
| -- ASN1STOP | |

QCL-Info field descriptions

bwp-Id
The DL BWP which the RS is located in.
cell
The UE's serving cell in which the referenceSignal is configured. If the field is absent, it
applies to the serving cell in which the TCI-State is configured. The RS can be located on a
serving cell other than the serving cell in which the TCI-State is configured only if the qcl-Type
is configured as typeC or typeD. See TS 38.214 [19] clause 5.1.5.
referenceSignal
Reference signal with which quasi-collocation information is provided as specified in TS
38.214 [19] subclause 5.1.5.
qcl-Type
QCL type as specified in TS 38.214 [19] subclause 5.1.5.

### ServCellIndex

The IE ServCelllndex concerns a short identity, used to uniquely identify a serving cell (i.e. the PCell, the PSCell or an SCell) across the cell groups. Value 0 applies for the PCell, while the SCellIndex that has previously been assigned applies for SCells.

ServCellIndex information element

-- ASN1START
-- TAG-SERVCELLINDEX-START
ServCellIndex ::= INTEGER (0..maxNrofServingCells-1)
-- TAG-SERVCELLINDEX-STOP
-- ASN1STOP

### ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts).

ServingCellConfig information element

| -- ASN1START | |
|---|---|
| -- TAG-SERVINGCELLCONFIG-START | |
| ServingCellConfig ::= | SEQUENCE { |
| ... | |
| ... | |
| pdcch-ServingCellConfig | SetupRelease { PDCCH- |
| ServingCellConfig } | OPTIONAL, -- Need |
| M | |
| pdsch-ServingCellConfig | SetupRelease { PDSCH- |
| ServingCellConfig } | OPTIONAL, -- Need |
| M | |
| ... | |

3GPP TS 38.212, V17.1.0 discusses Downlink Control Information (DCI) format related to uplink scheduling. One or more parts of 3GPP TS 38.212, V17.1.0 are quoted below:

### 7.3.1 DCI Formats

The DCI formats defined in table 7.3.1-1 are supported.

TABLE 7.3.1-1
DCI formats

| DCI format | Usage |
|---|---|
| 0_0 | Scheduling of PUSCH in one cell |
| 0_1 | Scheduling of one or multiple PUSCH in one |
| | cell, or indicating downlink feedback information |
| | for configured grant PUSCH (CG-DFI) |
| 0_2 | Scheduling of PUSCH in one cell |
| 1_0 | Scheduling of PDSCH in one cell |
| 1_1 | Scheduling of one or multiple PDSCH in one |
| | cell, and/or triggering one shot HARQ-ACK |
| | codebook feedback |
| 1_2 | Scheduling of PDSCH in one cell |

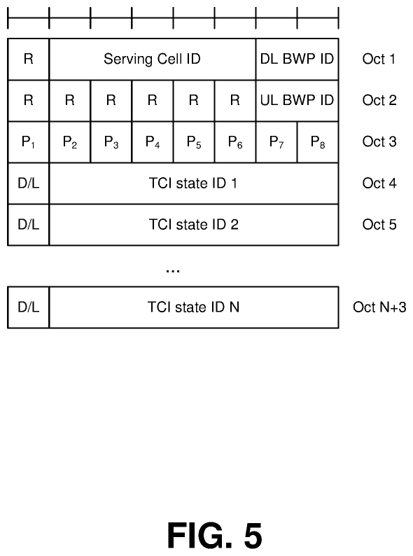

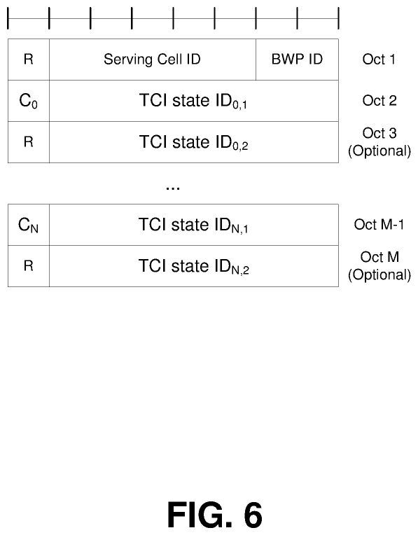

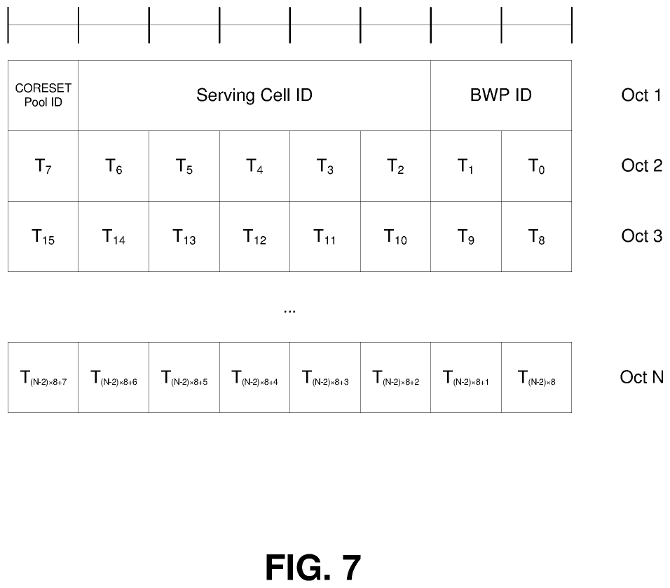

3GPP TS 38.321, V17.0.0 discusses TCI state related to MAC CE. Notably, FIG. 6.1.3.47-1 of Section 6.1.3.47 of 3GPP TS 38.321, V17.0.0, entitled “Unified TCI state activation/deactivation MAC CE”, is reproduced herein as FIG. 5. FIG. 6.1.3.24-1 of Section 6.1.3.24 of 3GPP TS 38.321, V17.0.0, entitled “Enhanced TCI States Activation/Deactivation for UE-specific PDSCH MAC CE”, is reproduced herein as FIG. 6. FIG. 6.1.3.14-1 of Section 6.1.3.14 of 3GPP TS 38.321, V17.0.0, entitled “TCI States Activation/Deactivation for UE-specific PDSCH MAC CE”, is reproduced herein as FIG. 7. One or more parts of 3GPP TS 38.321, V17.0.0 are quoted below:

### 6.1.3.47 Unified TCI States Activation/Deactivation MAC CE

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateListl , simultaneousU-TCI-UpdateList2, simultaneousU-TCI-UpdateList3 or simultaneousU-TCI-UpdateList4 as specified in TS 38.331 [5], this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. The length of the BWP ID field is 2 bits;
Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state;
D/U: This field indicate whether the TCI state ID in the same octet is for joint/downlink or uplink TCI state. If this field is set to 1, the TCI state ID in the same octet is for joint/downlink If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the UL-TCIState-Id as specified in TS 38.331 [5]. The maximum number of activated TCI states is 16;
R: Reserved bit, set to 0.

### FIG. 6.1.3.47-1: Unified TCI State Activation/Deactivation MAC CE

### 6.1.3.24 Enhanced TCI States Activation/Deactivation for UE-Specific PDSCH MAC CE

The Enhanced TCI States Activation/Deactivation for UE-specific PDSCH MAC CE is identified by a MAC PDU subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits;
Cᵢ: This field indicates whether the octet containing TCI state ID1,2 is present. If this field is set to 1, the octet containing TCI state ID1,2 is present. If this field is set to 0, the octet containing TCI state ID1,2 is not present;
TCI stateID_{i,j}: This field indicates the TCI state identified by TCI-StateId as specified in TS 38.331 [5], where i is the index of the codepoint of the DCI Transmission configuration indication field as specified in TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID0,1 and TCI state ID0,2 shall be mapped to the codepoint value 0, the second TCI codepoint with TCI state ID_{1,1} and TCI state ID_{1,2} shall be mapped to the codepoint value 1 and so on. The TCI state ID1,2 is optional based on the indication of the Cᵢ field. The maximum number of activated TCI codepoint is 8 and the maximum number of TCI states mapped to a TCI codepoint is 2.
R: Reserved bit, set to 0.

### FIG. 6.1.3.24-1: Enhanced TCI States Activation/Deactivation for UE-specific PDSCH MAC CE

### 6.1.3.14 TCI States Activation/Deactivation for UE-specific PDSCH MAC CE

The TCI States Activation/Deactivation for UE-specific PDSCH MAC CE is identified by a MAC subheader with LCID as specified in Table 6.2.1-1. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID: This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Tᵢ: If there is a TCI state with TCI-StateId i as specified in TS 38.331 [5], this field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in TS 38.214 [7]. The T field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states is 8. The activated TCI states can be associated with at most one PCI different from the Serving Cell PCI at a time;
CORESET Pool ID: This field indicates that mapping between the activated TCI states and the codepoint of the DCI Transmission Configuration Indication set by field Tᵢ is specific to the ControlResourceSead configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE.

### FIG. 6.1.3.14-1: TCI States Activation/Deactivation for UE-specific PDSCH MAC CE

One, some and/or all of the following terminology and assumptions may be used hereafter.
Base station (BS): a network central unit and/or a network node in New Radio (NR) that is used to control one or more transmission and/or reception points (TRPs) which are associated with one or more cells. Communication between a base station and one or more TRPs may be via fronthaul. Base station may be referred to as central unit (CU), eNB, gNB, and/or NodeB.
TRP: a TRP may provide network coverage and/or may directly communicate with UEs. A TRP may be referred to as distributed unit (DU) and/or network node.
Cell: a cell comprises one or more associated TRPs (e.g., coverage of the cell may comprise coverage of some and/or all associated TRP(s)). One cell may be controlled by one base station. Cell may be referred to as TRP group (TRPG).

In some examples, for Physical Downlink Shared Channel (PDSCH) in NR Rel-15 (NR Release 15), UE may receive Medium Access Control (MAC) Control Element (CE) (e.g., discussed in Section 6.1.3.14 in 3GPP TS 38.321, V17.0.0) for indicating up to 8 Transmission Configuration Indicator (TCI) states among a maximum number of TCI states (e.g., a maximum number of configured TCI states), such as 128 configured TCI states. UE may receive Downlink Control Information (DCI) with TCI field indicating a codepoint (e.g., one codepoint) associated with the MAC CE indicating TCI state. The term “codepoint” may also be referred to as “code-point”. In NR Rel-15, a beam indication for receiving a downlink (DL) transmission may consider (e.g., may only consider) transmission from a single TRP and/or transmission using a panel within a time duration (e.g., a time duration of at least one of one or more slots such as one slot, one or more mini-slots such as one mini-slot, etc.), such as from the perspective of UE. Alternatively and/or additionally, in Rel-15 NR, when an interval between a Physical Downlink Control Channel (PDCCH) and a PDSCH (and/or when an interval between the PDCCH and a Channel State Information Reference Signal (CSI-RS)) is smaller than a threshold (e.g., the threshold may correspond to timedurationForQCL and/or beam switching time for CSI-RS), a default beam indication may be needed. In this case, a TCI state associated with a Control Resource Set (CORESET) with a lowest CORESET ID in a latest slot of the PDSCH/CSI-RS may be used as a default beam.

In NR Rel-16 (NR Release 16), downlink transmission from multiple TRPs and/or multiple panels may be considered. For transmission from multiple TRPs and/or multiple panels, it may be implied that a single downlink transmission (e.g., transmission for a single Transport Block (TB)) may be performed using different beams from multiple TRPs and/or multiple panels (e.g., for transmission from multiple TRPs and/or multiple panels, it may be implied that a single downlink transmission may be performed using different beams from multiple TRPs and/or multiple panels). Alternatively and/or additionally, (for transmission from multiple TRPs and/or multiple panels, for example) it may be implied that a UE may receive multiple downlink transmissions from multiple TRPs and/or multiple panels within a time duration (e.g., a time duration of at least one of one or more slots such as one slot, one or more mini-slots such as one mini-slot, etc.). In NR Rel-16, one or more enhancements to ultra-reliable and low latency communications (URLLC) with consideration of multiple TRP scenario have been made. Alternatively and/or additionally, one or more Physical Downlink Shared Channel (PDSCH) repetition schemes may be used to improve reliability of receiving PDSCH. For example, the one or more PDSCH repetition schemes may comprise at least one of a Spatial Division Multiplexing (SDM) repetition scheme, a Frequency Division Multiplexing (FDM) repetition scheme, a mini-slot-based repetition scheme, a slot-based repetition scheme, etc. With multiple TRP (mTRP) PDSCH, a TB (e.g., one TB) may be transmitted by multiple beams, TCI states and/or spatial relations. In order to indicate two TCI states for mTRP by a single DCI, a MAC CE (e.g., discussed in Section 6.1.3.24 in 3GPP TS 38.321 V17.0.0) may be used for associating one or more codepoints of a TCI field to one or more TCI state IDs. In some examples, a MAC CE may associate up to 16 TCI state IDs (e.g., the MAC CE may associate one or more codepoints of the TCI field to up to 16 TCI state IDs), and a field (e.g., field Pi, which may correspond to a field in a unified TCI state activation/deactivation MAC CE shown in FIG. 5) may indicate either one TCI state or two TCI states for a codepoint of a TCI field (e.g., the codepoint of the TCI field may be associated with one or two TCI states). In some examples, a UE may receive a DCI with a TCI field indicating a codepoint (e.g., one codepoint), and if the one codepoint indicates one TCI state as MAC CE associating (e.g., if the MAC CE indicates that the one codepoint is associated with only one TCI state), the UE may consider single TRP (e.g., the UE may determine that the MAC CE and/or the one codepoint is associated with only a single TRP and/or may perform single TRP operation), while if the one codepoint indicates two TCI states as MAC CE associating (e.g., if the MAC CE indicates that the one codepoint is associated with two TCI states), the UE may consider mTRP (e.g., the UE may determine that the MAC CE and/or the one codepoint is associated with multiple TRPs and/or may perform mTRP operation).

In some examples, there are at least two mTRP operation mechanisms comprising a first mTRP operation mechanism corresponding to single DCI (sDCI) mTRP (for ideal backhaul, for example) and a second mTRP operation mechanism corresponding to multiple DCI (mDCI) mTRP (for non-ideal backhaul, for example). In some example, for sDCI mTRP, since sDCI mTRP may be used for ideal backhaul between two TRPs, sDCI from one TRP could schedule DL reception and UL transmission from two TRPs (e.g., in sDCI mTRP, a TRP may use one DCI to schedule DL reception and/or UL transmission for the TRP and another TRP). In some example, for mDCI mTRP, since mDCI mTRP may be used for non-ideal backhaul between two TRPs, each TRP may comprise respective DCI or scheduling information and/or cross TRP scheduling is not allowed (e.g., in mDCI mTRP, a TRP may not be able to schedule DL reception and/or UL reception for the TRP and another TRP using merely one DCI). In some examples, at least some of the foregoing description related to SDM, FDM and/or Time Division Multiplexing (TDM) repetition may be based on the first mTRP operation mechanism (e.g., sDCI mTRP). For the second mTRP operation mechanism (e.g., mDCI mTRP), a UE may be configured with CORESETPoolIndex for independently operating different TRPs. Alternatively and/or additionally, when a UE is configured with enable TwoDefaultTCI-State, and at least one TCI codepoint indicates two TCI states (e.g., DL TCI states), a UE can determine one or more default beams (e.g., one default beam or two default beams) when an interval between PDCCH and PDSCH is smaller than a threshold (e.g., the threshold may correspond to timedurationForQCL). The one or more default beams may be associated with one or more TCI states of a lowest TCI codepoint among TCI codepoints comprising multiple (e.g., two) different TCI states (e.g., two different DL TCI states).

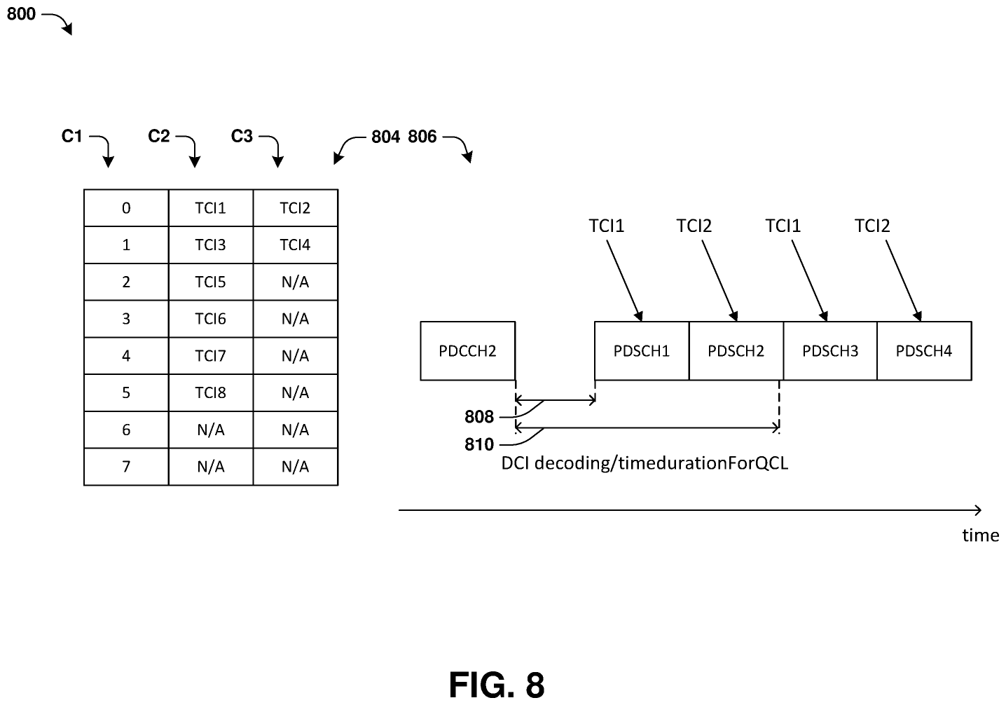

FIG. 8 illustrates an example scenario 800 associated with a slot-based repetition scheme. FIG. 8 provides a data structure 804 indicative of TCI codepoints (e.g., TCI codepoint indexes 0-7) in column C1, and TCI states associated with the TCI codepoints in columns C2 and C3. For example, the data structure 804 indicates that TCI codepoint 0 comprises TCI states TCI1 and TCI2, TCI codepoint 1 comprises TCI states TCI3 and TCI4, TCI codepoint 3 comprises TCI state TCI 5, etc. FIG. 8 provides a timing diagram 806. In an example, a UE associated with the example scenario 800 may be configured with and/or operate using the first mTRP operation mechanism (e.g., sDCI scheduling mTRP). In some examples, an interval 808 between PDCCH2 and PDSCH1 is smaller than a threshold 810 (e.g., timedurationForQCL). In some examples, the UE may use TCI codepoint 0(comprising TCI1 and TCI2) for receiving and/or buffering PDSCH1, PDSCH2, PDSCH3, and/or PDSCH4. For example, the UE may use TCI1 and/or TCI2 (of TCI codepoint 0) for receiving and/or buffering PDSCH1, PDSCH2, PDSCH3, and/or PDSCH4 based on the interval 808 being smaller than the threshold 810 (e.g., based on the interval 808 being smaller than the threshold 810, the UE is configured to use one or more TCI states of the lowest TCI codepoint among the TCI codepoints, which may be TCI codepoint 0 in the data structure 804).

In NR Rel-17 (NR Release 17), there may be an attempt to have a unified beam indication framework for DL and uplink (UL), for UE-specific DL channel and/or signal, and/or for UE-specific UL channel and/or signal. A motivation (e.g., a motivation to have the unified beam indication framework) may be to reduce signaling overhead and have a unified framework for DL channels and/or signals and/or for UL channels and/or signals. A motivation (e.g., a motivation to have the unified beam indication framework) may be that a UE (in most real deployments, for example) may use one or more same UE beams for downlink reception and/or one or more same UE beams for uplink transmission. In some examples, a UE may receive a MAC CE indicating (and/or activating) one or more TCI codepoints (e.g., up to 8 TCI codepoints). In some examples, one TCI codepoint may correspond to (i) one DL TCI state, (ii) one UL TCI state, (iii) one joint TCI state, and/or (iv) one DL TCI state and one UL TCI state. In some examples, a Radio Resource Control (RRC) configuration may indicate (e.g., instruct) whether to use separate TCI state (e.g., a UL TCI state and/or a DL TCI state) or to use joint TCI state (e.g., a joint UL and DL TCI state). In some examples, a UE may transmit a Hybrid Automatic Repeat Request (HARQ) (e.g., Acknowledgement (ACK)) in response to a beam indication DCI indicating a TCI codepoint (e.g., one TCI codepoint). In some examples, the RRC configuration may indicate (e.g., instruct) whether to use separate TCI state or to use joint TCI state upon (and/or after) a processing time elapsing after transmission of the HARQ. The beam indication DCI may schedule or may not schedule a DL assignment. In some examples, the beam indication DCI is DCI format 1_1 or DCI format 1_2. A TCI state (in NR Rel-17, for example) may be associated with a source Reference Signal (RS) in a serving cell or in an additional cell. In some examples, the additional cell may be correspond to a cell having a Physical Cell Identity (PCI) different than a PCI of the serving cell. In some examples, the UE may communicate with the additional cell. In some examples, number of additional cell could be configured with up to 7 (e.g., the UE may be configured with up to seven additional cells). The one or more TCI codepoints indicated by the MAC CE may comprise one or more TCI states associated with the serving cell and an additional cell. In some examples, the one or more TCI codepoints indicated by the MAC CE may comprise one or more TCI states associated with only one additional cell. In an example, it may not be allowed for TCI codepoint i (indicated by the MAC CE, for example) to comprise TCI state associated with an additional cell with PCI=Z and/or TCI codepoint j (indicated by the MAC CE, for example) to comprise TCI state associated with an additional cell with PCI=Y. In an example, it may be allowed for TCI codepoint i (indicated by the MAC CE, for example) to comprise TCI state associated with a serving cell with PCI=X and TCI codepoint j (indicated by the MAC CE, for example) to comprise TCI state associated with an additional cell with PCI=Y. One or more channels for which this mechanism can be applied may be discussed below.

In some examples, for a non-UE dedicated PDCCH (e.g., PDCCH associated with CORESET 0 and/or associated with a Common Search Space (CSS) other than Type-3 CSS), when CORESET is configured with enabled followUnifiedTCIstate (e.g., followUnifiedTCIstate is enabled for the CORESET), a PDCCH (e.g., a non-UE dedicated PDCCH) in the CORESET may apply a TCI state from the beam indication DCI. Alternatively and/or additionally, when CORESET is not configured with followUnifiedTCIstate (e.g., when followUnifiedTCIstate is not enabled for the CORESET), a PDCCH (e.g., a non-UE dedicated PDCCH) in the CORESET may be based on an additional MAC CE for activating a TCI state (e.g., one TCI state) as quasi-colocation (QCL) assumption for receiving the PDCCH (e.g., the non-UE dedicated PDCCH) and/or a Synchronization Signal (SS) (e.g., primary synchronization signal, secondary synchronization signal) Physical Broadcast Channel (PBCH) (SS-PBCH) may be used as QCL assumption for receiving the PDCCH (e.g., the non-UE dedicated PDCCH). In some examples, similar criteria may be used for one or more PDSCHs and/or CSI-RS s (e.g., one or more scheduled PDSCHs and/or one or more scheduled CSI-RS s) associated with a non-UE dedicated PDCCH. For example, a PDSCH and/or a CSI-RS associated with a non-UE dedicated PDCCH may be received using one or more of the techniques provided herein with respect to receiving a non-UE dedicated PDCCH. Alternatively and/or additionally, for receiving a non-UE dedicated PDCCH, a non-UE dedicated PDSCH, and/or a non-UE dedicated CSI-RS, a TCI state for reception and/or buffering may need to be associated with RS in serving cell. For example, TCI state associated with RS in the additional cell (e.g., the one additional cell) may not be allowed to be used for receiving and/or buffering a non-UE dedicated PDCCH, a non-UE dedicated PDSCH, and/or a non-UE dedicated CSI-RS.

In some examples, for a UE dedicated PDCCH (e.g., PDCCH associated with UE-specific Search Space (USS) and/or Type-3 CSS in a CORESET other than CORESET 0), a (e.g., a UE dedicated PDCCH) in the CORESET may apply (e.g., directly apply) a TCI state from the beam indication DCI. Same criteria for scheduled/associated PDSCH/CSI-RS related to UE dedicated PDCCH. In some examples, similar criteria may be used for one or more PDSCHs and/or CSI-RS s (e.g., one or more scheduled PDSCHs and/or one or more scheduled CSI-RS s) associated with a UE dedicated PDCCH. For example, a PDSCH and/or a CSI-RS associated with a UE dedicated PDCCH may be received using one or more of the techniques provided herein with respect to receiving a UE dedicated PDCCH.

In Rel-18 (Release 18), a TCI codepoint (e.g., one TCI codepoint) may comprise multiple (e.g., two) DL TCI states for mTRP operation. In some examples, the UE may not know whether PDCCH is a non-UE dedicated PDCCH or a UE dedicated PDCCH before decoding (e.g., before decoding the PDCCH). In some examples, an interval between PDCCH and PDSCH is smaller than timedurationForQCL. In some examples, prior to receiving the PDSCH, the UE may not know whether the PDCCH is a non-UE dedicated PDCCH or a UE dedicated PDCCH due to the interval being smaller than timedurationForQCL. In some examples, the UE may not be able to determine which TCI state to use as QCL assumption for receiving and/or buffering the PDSCH (e.g., the UE may not be able to determine which TCI state to use for receiving and/or buffering the PDSCH since the UE does not know whether the PDCCH is a non-UE dedicated PDCCH or a UE dedicated PDCCH). This issue (e.g., the UE not knowing whether the PDCH is a non-UE dedicated PDCCH or a UE dedicated PDCCH and/or the UE not being able to determine which TCI state to use for the PDSCH) may happen when (i) there is a non-UE dedicated PDCCH (e.g., the PDCCH is a non-UE dedicated PDCCH), (ii) self slot scheduling is used (for scheduling the PDCCH and/or the PDSCH, for example, such as where the PDCCH and the PDSCH are in the same slot) and/or (iii) scheduling offset is small (for reducing latency, for example). On the other hand, as a TCI codepoint (e.g., one TCI codepoint) may comprise a DL TCI state (e.g., one DL TCI state) associated with RS in a serving and/or additional cell and one or more other DL TCI states (e.g., one other DC TCI state other than the one DL TCI state) associated with RS in a serving and/or additional cell. An example combination associated with two TCI states for one TCI codepoint indicated by a beam indication DCI may be (1-st DL/joint TCI, 2-nd DL/joint TCI) corresponding to (serving cell, additional cell), (serving cell, serving cell), and/or (additional cell, additional cell). For example, (1-st DL/joint TCI, 2-nd DL/joint TCI) corresponding to (serving cell, additional cell) may indicate that 1-st DL/joint TCI corresponds to serving cell and 2-nd DL/joint TCI corresponds to an additional cell. When (i) UE supports enableTwoDefaultTCI-State and (ii) the interval between PDCCH and PDSCH/CSI-RS (e.g., an earliest scheduled PDSCH/CSI-RS after the PDCCH) is smaller than a threshold (and/or a scheduling offset, that may be associated with the interval, is smaller than a threshold), it may be difficult and/or impossible to determine which QCL assumption of TCI states for the UE to use to receive and/or buffer one or more PDSCHs. In the present disclosure, the term “PDSCH/CSI-RS” may refer to PDSCH and/or CSI-RS. For example, it may be difficult and/or impossible to determine TCI states (e.g., two default TCI states) and/or beams (e.g., two default beams) for receiving one or more PDSCHs since the UE may not know whether PDCCH is a non-UE dedicated PDCCH or a UE dedicated PDCCH before decoding the PDCCH.

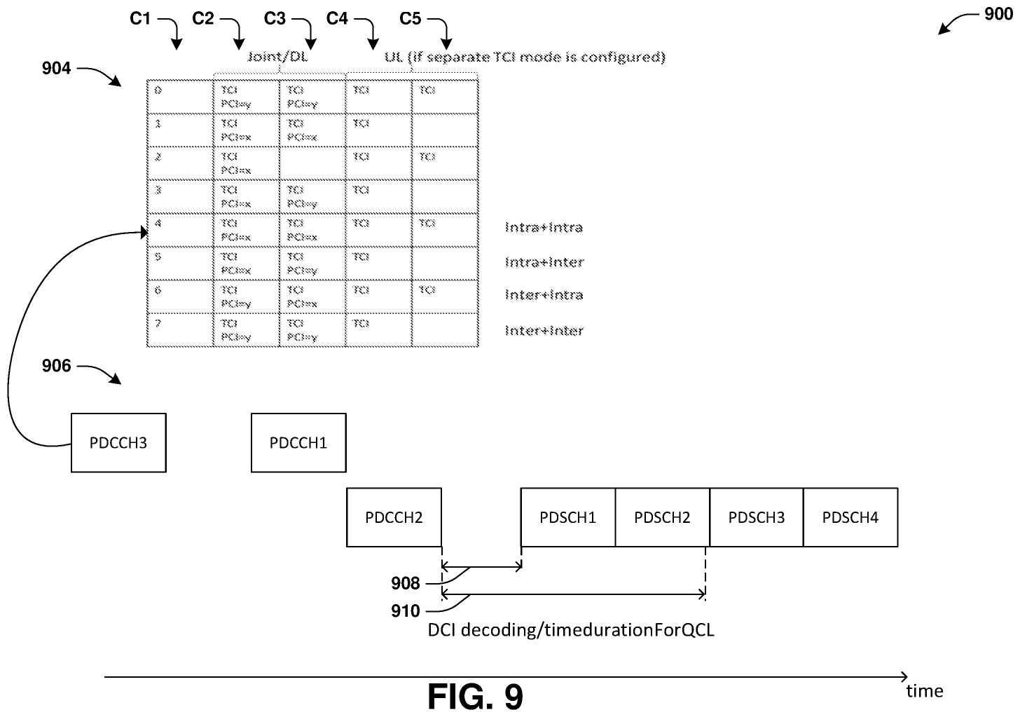

FIG. 9 illustrates an example scenario 900 associated with a UE. FIG. 9 provides a data structure 904 indicative of TCI codepoints (e.g., TCI codepoint indexes 0-7) in column C1, and TCI states associated with the TCI codepoints in columns C2, C3, C4 and C5 (e.g., columns C2 and C3 of the data structure 904 may provide DL and/or joint TCI states, and/or columns C4 and C5 of the data structure may provide UL TCI states). FIG. 9 provides a timing diagram 906. In some examples, in the example scenario 900, the UE does not know at least some information about USS, CSS, UE-dedicated PDCCH, non-UE dedicated PDCCH, PDCCH1 and/or PDCCH2 before decoding PDCCH (e.g., before decoding PDCCH2) and/or before an end of timedurationForQCL 910, the UE may need to buffer and/or receive PDSCH (e.g., PDSCH1 and/or PDSCH2) based on two DL/joint TCI states according to a beam indication DCI. In the present disclosure, the term “DL/joint TCI state” may refer to a DL TCI state (e.g., a TCI state used by the UE for receiving DL transmissions) and/or a joint TCI state (e.g., a TCI state used by the UE for receiving DL transmission and/or transmitting UL transmission). In some examples, PDCCH3 may be received by the UE (prior to receiving PDCCH1 and PDCCH2, for example). PDCCH3 may comprise the beam indication DCI. In an example, the UE may buffer and/or receive PDSCH (e.g., PDSCH1 and/or PDSCH2) based on two DL/joint TCI states according to the beam indication DCI (e.g., PDCCH3) in response to an interval 908 (e.g., scheduling offset) between PDCCH2 and PDSCH1 being smaller than a threshold corresponding to the timedurationForQCL 910). In an example, the UE may perform mTRP operation and/or communicate with multiple (e.g., two) TRPs. Each TCI codepoint (indicated by the data structure 904, for example) may correspond to zero, one, or two DL/joint TCI states. A DL/joint TCI state (e.g., one DL/joint TCI state) may be associated with at least one RS (and/or may be associated with a Type-D QCL assumption to the one RS), wherein the one RS is associated with a serving cell PCI (e.g., PCI=x) or an additional and/or non-serving cell PCI (e.g., PCI=y). In an example, when the beam indication DCI (e.g., PDCCH3) indicates TCI codepoint with index 4 (in column C1 of the data structure 904, for example), the two DL/joint TCI states may correspond to the same serving cell, e.g., both of the two DL/joint TCI states are associated with a RS (e.g., intra cell RS) associated with the serving cell PCI (e.g., PCx) (which is a case of an intra cell+intra cell, for example). QCL assumption for receiving/buffering PDSCH1-4 may correspond to the two DL/joint TCI states in the TCI codepoint with index 4 (e.g., QCL assumption for receiving/buffering PDSCH1-4 may correspond to the two DL/joint TCI states in the TCI codepoint with index 4 based on the beam indication DCI, such as PDCCH3, being indicative of the TCI codepoint with index 4). However, when the beam indication DCI indicates TCI codepoint with index 7 (e.g., TCI codepoint with index 7 may comprise two DL/joint TCI states that are both associated with an inter-cell RS associated with the additional and/or non-serving cell PCI, e.g., PCI=y), the UE may use inter-cell RS for receiving/buffering non-UE dedicated PDSCH, which means the UE may not be able to decode the non-UE dedicated PDSCH successfully since the non-UE-dedicated PDSCH may be common and/or cell-specific for one cell. Alternatively and/or additionally, once beam indication DCI indicates TCI codepoint with index 5 or 6, default beam and/or default TCI states design may need further design.

In some examples, one or more other issues may be associated with a UE not supporting enableTwoDefaultTCI-State and/or a scheduling offset (e.g., an interval between PDCCH and a PDSCH/CSI-RS, such as an earliest scheduled PDSCH/CSI-RS after the PDCCH) is smaller than a threshold, and/or a default beam and/or default TCI state for receiving/buffering PDSCH may be further considered. In the present disclosure, the term “receiving/buffering” may refer to receiving and/or buffering.

### Concept A

In Concept A, UE determines two default beams based on a lowest TCI codepoint among TCI codepoints comprising two different TCI states, wherein the two different TCI states are associated with a first cell. In some examples, the two different TCI states are DL/joint TCI states. In some examples, the first cell is a serving cell. In some examples, for a TCI codepoint (e.g., one TCI codepoint) comprising a first TCI state and a second TCI state associated with different cells (e.g., the first TCI state is associated with a cell that is different than a cell associated with the second TCI state), the UE is not allowed to use the TCI codepoint (e.g., the one TCI codepoint) for determining default beams. In some examples, for another TCI codepoint (e.g., another one TCI codepoint) comprising a third TCI state and a fourth TCI state associated with a same cell which is a second cell (e.g., both the third TCI state and the fourth TCI state are associated with the second cell), the UE is not allowed to use the another TCI codepoint for determining default beams. The second cell is with different PCI than the first cell (e.g., a PCI of the second cell is different than a PCI, such as a serving cell PCI, of the first cell). The second cell may be associated with an additionalPCIIndex which is a value (e.g., one integer value) from at least 1 to at most 7. The UE may support having (e.g., the UE may have the capability to have) two default beams for multiple TRP operation (e.g., the UE is configured with enableTwoDefaultTCI-States and/or enableTwoDefaultTCI-States is enabled for the UE).

In some examples, the UE applies two DL/joint TCI states of TCI codepoint according to beam indication DCI. In some examples, the beam indication DCI is delivered by a third PDCCH. The UE may receive UE-dedicated PDCCH and/or PDSCH reception based on the two DL/joint TCI states. The UE may monitor a second CORESET and/or a second PDCCH based on a DL/joint TCI state (e.g., one DL/joint TCI state) of the two DL/joint TCI states. The UE may monitor a first CORESET and/or a first PDCCH based on a DL/joint TCI state (e.g., one DL/joint TCI state) of the two DL/joint TCI states. Alternatively and/or additionally, the UE may monitor the first CORESET and/or the first PDCCH based on a third DL/joint TCI state associated with the first CORESET. The third DL/joint TCI state may be different from each of the two DL/joint TCI states. In some examples, the first CORESET is associated with UE-dedicated signal/channel. In the present disclosure, the term “signal/channel” may refer to signal and/or channel. In some examples, the second CORESET is associated with non-UE-dedicated signal/channel.

In some examples, when a scheduling offset (e.g., an interval between PDCCH and at least one of a PDSCH, a CSI-RS, etc.) is smaller than a threshold and the two DL/joint TCI states of TCI codepoint is associated with RS in the second cell, the UE determines two default beams based on lowest TCI codepoint among TCI codepoints containing two different TCI states and the two different TCI states are associated with the first cell.

In some examples, when the scheduling offset is smaller than a threshold and one of the two DL/joint TCI states of TCI codepoint is associated with RS in the second cell and the other one of the two DL/joint TCI states of TCI codepoint is associated with RS in the first cell, the UE determines two default beams based on lowest TCI codepoint among TCI codepoints comprising two different TCI states, wherein the two different TCI states are associated with the first cell. Alternatively and/or additionally, when the scheduling offset is smaller than a threshold and one of the two DL/joint TCI states of TCI codepoint is associated with RS in the second cell and the other one of the two DL/joint TCI states of TCI codepoint is associated with RS in the first cell, the UE determines one of the two default beams based on one DL/joint TCI states of TCI codepoint which is associated with the first cell. In some examples, the UE determines the other one of the two default beams based on 1-st DL/joint TCI state or 2-nd DL/joint TCI state in the lowest TCI codepoint comprising the 1-st or 2-nd DL/joint TCI state associated with the first cell (e.g., the lowest TCI codepoint may correspond to a TCI codepoint with a lowest TCI codepoint index among TCI codepoints comprising a DL/joint TCI state associated with the first cell). In some examples, when a beam indication DCI indicates a TCI codepoint associated with one of a 1-st DL/joint TCI state that is associated with the second cell and a 2-nd DL/joint TCI state that is associated with the first cell, the UE may (i) determine one of the two default beams based on the 2-nd DL/joint TCI state that is associated with the first cell, and/or (ii) determine the other one of the two default beams based on a 1-st DL/joint TCI state of a TCI codepoint with a lowest TCI codepoint among TCI codepoints comprising a 1-st DL/joint TCI state associated with the first cell). In some examples, when a beam indication DCI indicates a TCI codepoint associated with one of a 2-nd DL/joint TCI state that is associated with the second cell and a 1-st DL/joint TCI state that is associated with the first cell, the UE may (i) determine one of the two default beams based on the 1-st DL/joint TCI state that is associated with the first cell, and/or (ii) determine the other one of the two default beams based on a 2-nd DL/joint TCI state of a TCI codepoint with a lowest TCI codepoint among TCI codepoints comprising a 2-nd DL/joint TCI state associated with the first cell).

In some examples, when the scheduling offset is smaller than a threshold and the two DL/joint TCI states of TCI codepoint are associated with RS in the first cell, the UE determines two default beams based on the two DL/joint TCI states of TCI codepoint.

In some examples, when beam indication DCI indicates two DL/joint TCI states, the first PDCCH and/or the second PDCCH may provide information corresponding to using one or two of the two DL/joint TCI states. In some examples, the first PDCCH and/or the second PDCCH may provide a number of DL/joint TCI states to use for receiving PDSCH (e.g., scheduled PDSCH). In an example, repetition number for a PDSCH (which may be provided by the first PDCCH and/or the second PDCCH, for example) may be associated with time domain resource allocation field in DCI, and if the first PDCCH and/or the second PDCCH indicate using one DL/joint TCI state (e.g., if the first PDCCH and/or the second PDCCH indicate that a PDSCH should be received using one DL/joint TCI state of the two DL/joint TCI states), the UE may receive the PDSCH (and/or the number of PDSCH repetitions) based on the indication of one DL/joint TCI state (e.g., the indication in the first PDCCH and/or the second PDCCH to use one DL/joint TCI state for receiving the PDSCH), for example, the UE may use merely the one DL/joint TCI state of the two DL/joint TCI states to receive the PDSCH and/or may not use another DL/joint TCI state (other than the one DL/joint TCI state) to receive the PDSCH. In some examples, if the first PDCCH and/or the second PDCCH indicate using two DL/joint TCI states, the UE may receive PDSCH and the number of PDSCH repetitions based on the two DL/joint TCI states (indicated by the beam indication DCI, for example).

In some examples, the information (provided by the first PDCCH and/or the second PDCCH) may be indicated (e.g., explicitly and/or implicitly indicated) by the first PDCCH and/or the second PDCCH. In some examples, the information may be indicated by (and/or may be determined based on) a CORESETPoolIndex of the first CORESET and/or the second CORESET. In some examples, 1-st DL/joint TCI state of the two DL/joint TCI states is associated with CORESETPoolIndex=0. In some examples, 2-nd DL/joint TCI state of the two DL/joint TCI states is associated with CORESETPoolIndex=1. In some examples, the first PDCCH and/or the second PDCCH may indicate an order of the two DL/joint TCI states to be: 1-st DL/joint TCI state of the two DL/joint TCI states followed by the 2-nd DL/joint TCI state of the two DL/joint TCI state. In some examples, the first PDCCH and/or the second PDCCH may indicate an order of the two DL/joint TCI states to be: 2-nd DL/joint TCI state of the two DL/joint TCI states followed by the 1-st DL/joint TCI state of the two DL/joint TCI states.

In some examples, the UE determines two default beams (at least) when a beam indication DCI indicates two DL/joint TCI states. In some examples, regardless of a number of DL/joint TCI states the first PDCCH and/or the second PDCCH indicate should be used for receiving PDSCH, the UE determines two default beams (at least) when a beam indication DCI indicates two DL/joint TCI states. In some examples, for at least one TCI codepoint comprising two DL/joint TCI states, the UE does not determine two default beams when a second TCI codepoint (e.g., another codepoint different than the at least one TCI codepoint), indicated by beam indication DCI, comprises one DL/joint TCI state (e.g., the second TCI codepoint indicated by the beam indication DCI comprises merely one DL/joint TCI state).

In some examples, when a TCI codepoint (e.g., the second TCI codepoint), indicated by beam indication DCI, comprises one DL/joint TCI state (e.g., comprises merely the DL/joint TCI state and/or does not comprise any other DL/joint TCI state) and the scheduling offset is smaller than a threshold, a cell of an RS associated with the one DL/joint TCI state may impact default beam determination. For example, which cell the RS associated with the one DL/joint TCI state is associated with may influence determination of a first default beam (e.g., one default beam) of the two default beams.

In some examples, when the one DL/joint TCI state (of the second TCI codepoint indicated by beam indication DCI, for example) is associated with RS in the first cell, the first default beam (e.g., the one default beam) is based on the one DL/joint TCI state (e.g., the first default beam may be determined to comprise the one DL/joint TCI state based on one DL/joint TCI state being associated with RS in the first cell).

In some examples, when the one DL/joint TCI state (of the second TCI codepoint indicated by beam indication DCI, for example) is associated with RS in the second cell, the first default beam (e.g., the one default beam) is based on a fifth TCI state. In some examples, the fifth TCI state is based on (e.g., corresponds to) a TCI state of a CORESET with a lowest ID in a latest slot of PDSCH(s) and/or associated with scheduled PDSCH(s) and/or before scheduled PDSCH(s). In some examples, the first TCI state is based on (e.g., corresponds to) a TCI state of a CORESET with a lowest ID among (i) one or more CORESETs monitored by the UE in a latest slot of PDSCH (e.g., the latest slot of PDSCH may correspond to a last slot of one or more scheduled PDSCHs, such as a last slot of one or more slots in which the one or more scheduled PDSCHs are scheduled), (ii) one or more CORESETs associated with the one or more scheduled PDSCHs, and/or (iii) one or more CORESETs associated with one or more slots before the one or more scheduled PDSCHs. In some examples, a third CORESET may be monitored and/or received in the latest slot of PDSCH. In some examples, the third CORESET may have a lowest CORESET index among a plurality of CORESETs monitored in the latest slot of PDSCH (e.g., a CORESET index of the third CORESET is the lowest CORESET index among CORESET indexes associated with the plurality of CORESETs). In some examples, the UE may receive a MAC CE for receiving the third CORESET based on the fifth TCI state. In some examples, the fifth TCI state is DL/joint TCI state. In some examples, the fifth TCI state is associated with RS in the first cell.

In some examples, when the UE is not configured with CORESETPoolIndex, the UE operates using the first mTRP operation mechanism (e.g., sDCI mTRP). In some examples, the UE receives mTRP PDSCH(s) based on one scheduling DCI (rather than respective DCI with different CORESETPoolIndex, for example).

In some examples, the UE may be configured with one or more serving cells comprising the first cell and a third cell (e.g., the one or more serving cells may not comprise the second cell).

In some examples, the UE may receive UE-dedicated PDSCH/PDCCH on the first cell and/or the third cell based on DL/joint TCI state indicated by beam indication DCI.

In some examples, the first cell and the third cell may be in same frequency band.

In some examples, one TCI codepoint is associated with two DL/joint TCI states. In some examples, 1-st DL/joint TCI state of the two DL/joint TCI states is associated with a lower octet index than 2-nd DL/joint TCI state of the two DL/joint TCI states. In some examples, both a DL/joint TCI state associated with octet index i and a DL/joint TCI state associated with index j are associated with (e.g., included in) one TCI codepoint. In some examples, if i is smaller than j, 1-st DL/joint TCI state for the one TCI codepoint is DL/joint TCI state associated with octet index i and 2-nd DL/joint TCI state for the one TCI codepoint is DL/joint TCI state associated with octet index j.

In some examples, MAC CE is used for associating one or more TCI states and TCI codepoint. In some examples, MAC CE is used for associating one or more TCI states and TCI codepoint (e.g., the MAC CE may indicate that the TCI codepoint is associated with the one or more TCI states), wherein the TCI codepoint may be used for indicating a TCI state for receiving UE-dedicated PDCCH (e.g., the one or more TCI states associated with the TCI codepoint may be used for receiving UE-dedicated PDCCH). In some examples, the TCI codepoint is used for indicating TCI state for transmitting UE-dedicated Physical Uplink Shared Channel (PUSCH)/Physical Uplink Control Channel (PUCCH). In some examples, the UE is not provided with another MAC CE that is used for associating TCI state and TCI codepoint for PDSCH (e.g., merely for PDSCH).

In some examples, when the two DL/joint TCI states are associated with same cell and a scheduling offset (e.g., an interval between PDCCH and at least one of a PDSCH, a CSI-RS, etc.) meets (e.g., is larger than or equal to) a threshold, the UE may receive UE-dedicated PDCCH and/or PDSCH reception based on the two DL/joint TCI states.

In some examples, when the scheduling offset meets (e.g., is larger than or equal to) a threshold, for PDSCH scheduled by the first PDCCH, the UE receives the PDSCH based on the third TCI state. Alternatively and/or additionally, when the scheduling offset is larger than or equal to a threshold, for PDSCH scheduled by the first PDCCH, the UE receives the PDSCH based on one of the two DL/joint TCI states. In some examples, the one of the two DL/joint TCI states (used by the UE to receive the PDSCH, for example) may be 1-st DL/joint TCI state the two DL/joint TCI states, may be 2-nd DL/joint TCI state the two DL/joint TCI states and/or may be associated with same CORESETPoolIndex (e.g., the same CORESETPoolIndex that the UE is configured with).

When the scheduling offset meets (e.g., is larger than or equal to) a threshold, for PDSCHs scheduled by the second PDCCH, the UE receives the PDSCHs based on the two DL/joint TCI states.

In some examples, DCI format 1_1 in the first CORESET does not comprise TCI field (e.g., one or more DCIs, in the first CORESET, that correspond to DCI format 1_1 do not comprise TCI field).

In some examples, DCI format 1_2 in the first CORESET does not comprise TCI field (e.g., one or more DCIs, in the first CORESET, that correspond to DCI format 1_2 do not comprise TCI field).

In some examples, DCI format 1_1 in the first CORESET comprises TCI field (e.g., one or more DCIs, in the first CORESET, that correspond to DCI format 1_1 comprise TCI field).

In some examples, DCI format 1_2 in the first CORESET comprises TCI field (e.g., one or more DCIs, in the first CORESET, that correspond to DCI format 1_2 comprise TCI field).

In some examples, DCI format 1_1 in the second CORESET does not comprise TCI field (e.g., one or more DCIs, in the second CORESET, that correspond to DCI format 1_1 do not comprise TCI field).

In some examples, DCI format 1_2 in the second CORESET does not comprise TCI field (e.g., one or more DCIs, in the second CORESET, that correspond to DCI format 1_2 do not comprise TCI field).

In some examples, DCI format 1_1 in the second CORESET comprises TCI field (e.g., one or more DCIs, in the second CORESET, that correspond to DCI format 1_1 comprise TCI field).

In some examples, DCI format 1_2 in the second CORESET comprises TCI field (e.g., one or more DCIs, in the second CORESET, that correspond to DCI format 1_2 comprise TCI field).

In some examples, a MAC CE for associating TCI codepoint and one or more TCI states (e.g., the MAC CE may indicate that the one or more TCI states are associated with, such as included in, the TCI codepoint) may comprise up to M TCI codepoint(s) and/or N TCI state(s). In some examples, MAC CE may comprise one TCI codepoint (e.g., M=1). In some examples, MAC CE may comprise a plurality of TCI codepoint (e.g., M>1). In some examples, the N TCI state(s) may comprise DL/joint TCI state(s) and/or UL TCI state(s). In some examples, each TCI state of the N TCI state(s) may comprises a DL TCI state, a joint TCI state and/or a UL TCI state. In some examples, a TCI codepoint (e.g., one TCI codepoint) may be associated with (e.g., the TCI codepoint may comprise) up to 2 DL/joint TCI states and/or up to 2 UL TCI states.

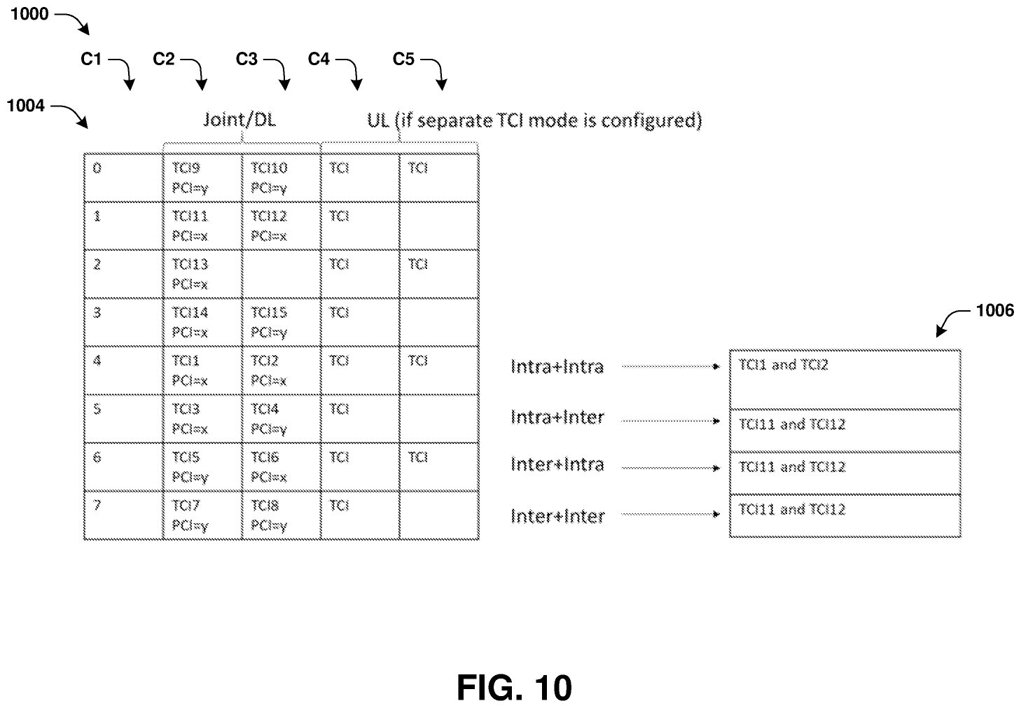

FIG. 10 illustrates an example scenario 1000 associated with a UE. FIG. 10 provides a data structure 1004 indicative of TCI codepoints (e.g., TCI codepoint indexes 0˜7) in column C1, and TCI states associated with the TCI codepoints in columns C2, C3, C4 and C5 (e.g., columns C2 and C3 of the data structure 1004 may provide DL and/or joint TCI states, and/or columns C4 and C5 of the data structure may provide UL TCI states).

In some examples, in the example scenario 1000, PCI=x corresponds to a serving cell (e.g., the first cell), such as one serving cell, and PCI=y corresponds to an additional and/or non-serving cell (e.g., the second cell), such as one additional and/or non-serving cell.

For TCI codepoint 4 (i.e., TCI codepoint with TCI codepoint index “4” in column C1 of the data structure 1004), both DL/joint TCIs in the TCI codepoint 4 are associated with RS in the serving cell (e.g., both DL/joint TCIs in the TCI codepoint 4 are associated with serving cell PCI=x). The UE may support receiving (e.g., may have capability to receive) PDSCHs using two default beams and/or two default TCI states. When transmission(s) are scheduled according to the timing diagram 906 in FIG. 9, UE may determine default TCI state or default beam for receiving PDSCH1, PDSCH2, PDSCH3, and/or PDSCH4. When scheduling offset (e.g., the interval 908 between PDCCH2 and PDSCH1) is smaller than a threshold (e.g., the timedurationForQCL 910) and beam indication DCI (e.g., PDCCH3) indicates TCI codepoint 4, the two default TCI states and/or the two default beams may be determined to be TCI1 and TCI2. In some examples, a rationale is as both TCI1 and TCI2 are associated with serving cell (e.g., PCx), which UE may receive PDCCH in common search space or receive non-UE dedicated PDCCH (e.g., the UE may use TCI1 and/or TCI2 to receive PDCCH in common search space and/or receive non-UE dedicated PDCCH). In some examples, TCI1 and/or TCI2 (e.g., both TCI1 and TCI2) may be used to receive PDSCH1, PDSCH2, PDSCH3, and/or PDSCH4. In some examples, UE may receive PDSCH1-4 according to (TCI1, TCI2, TCI1, TCI2) (e.g., use TCI1 for PDSCH1, use TCI2 for PDSCH2, use TCI1 for PDSCH3, use TCI2 for PDSCH4), or (TCI2, TCI1, TCI2, TCI1) or (TCI1, TCI1, TCI2, TCI2) or (TCI2, TCI2, TCI1, TCI1) or other order. In some examples, PDCCH1 and/or PDCCH2 in the timing diagram 906 of FIG. 9 may be a scheduling DCI for PDSCH (e.g., PDCCH1 and/or PDCCH2 may schedule PDSCH1, PDSCH2, PDSCH3, and/or PDSCH4). After decoding PDCCH1 and/or PDCCH2, even PDCCH1 and/or PDCCH2 schedules sTRP PDSCH, the UE receives/buffers PDSCH1-4 based on the determined two default beams (e.g., even if PDCCH1 and/or PDCCH2 schedules sTRP PDSCH, the UE receives/buffers PDSCH1-4 based on the determined two default beams). In some examples, a rationale (for the UE to receive/buffer PDSCH1-4 based on the determined two default beams, for example) may be that a number of TCI states indicated by beam indication DCI is 2 or for mTRP operation and when scheduling offset is smaller than a threshold, UE needs to receive/buffer PDSCHs first before decoding PDCCH (since the UE does not have sufficient time to decode PDCCH before receiving/buffering the PDSCHs, for example).

For TCI codepoints 5-7 (i.e., TCI codepoints with TCI codepoint indexes “5”, “6” and “7” in column C1 of the data structure 1004), at least one DL/joint TCI in each of TCI codepoints 5-7 is associated with RS (e.g., PCI=y) in the additional and/or non-serving cell (e.g., the second cell). The UE may support receiving (e.g., may have capability to receive) PDSCHs by two default beam and/or two default TCI states. When transmission(s) are scheduled according to the timing diagram 906 in FIG. 9, UE may determine default TCI state or default beam for receiving PDSCH1, PDSCH2, PDSCH3, and/or PDSCH4. When scheduling offset (e.g., the interval 908 between PDCCH2 and PDSCH1) is smaller than a threshold (e.g., the timedurationForQCL 910) and beam indication DCI indicates at least one of TCI codepoint 5,6, or 7, the two default TCI states and/or the two default beams may not be based on TCI states in TCI codepoint indicated by beam indication DCI. In some examples, the two default TCI states and/or the two default beams may be based on (e.g., may comprise) TCI11 and TCI12. In some examples, the two default TCI states and/or the two default beams are based on (e.g., comprise TCI states of) TCI codepoint 1. For example, the two default TCI states and/or the two default beams may be based on (e.g., may comprise TCI states of) TCI codepoint 1 based on TCI codepoint 1 comprising DL/joint TCI states that are (both) associated with serving cell (e.g., PCI=x). For example, TCI codepoint 1 may be used to determine the two default TCI states and/or the two default beams (e.g., the two default TCI states and/or the two default beams may comprise the two DL/joint TCI states in TCI codepoint 1) based on the two DL/joint TCI states in TCI codepoint 1 (both) being associated with serving cell (e.g., PCI=x). In some examples, the two default TCI states and/or the two default beams may be based on (e.g., may comprise TCI states of) TCI codepoint 1 based on TCI codepoint 1 having the lowest TCI codepoint index among one or more TCI codepoints (e.g., TCI codepoint 1 and TCI codepoint 4) that comprise DL/joint TCI states that are (both) associated with serving cell (e.g., PCI=x). Alternatively and/or additionally, a network restriction (e.g., one network restriction) may be considered in which the network shall indicate TCI codepoint 0 associated with both DL/joint TCI states associated with serving cell (e.g., PCI=x). In some examples, a rationale is as TCI11 and TCI12 in TCI codepoint 1 are both associated with serving cell (e.g., PCI=x), which UE may receive PDCCH in common search space or receive non-UE dedicated PDCCH (e.g., the UE may use TCI11 and/or TCI12 to receive PDCCH in common search space and/or receive non-UE dedicated PDCCH). In some examples, UE may receive PDSCH1-4 according to (TCI11, TCI12, TCI11, TCI12) or (TCI12, TCI11, TCI12, TCI11) or (TCI11, TCI11, TCI12, TCI12) or (TCI12, TCI12, TCI11, TCI11) or other order. In some examples, PDCCH1 and/or PDCCH2 in the timing diagram 906 of FIG. 9 may be a scheduling DCI for PDSCH (e.g., PDCCH1 and/or PDCCH2 may schedule PDSCH1, PDSCH2, PDSCH3, and/or PDSCH4). After decoding PDCCH1 and/or PDCCH2, even PDCCH1 and/or PDCCH2 schedules sTRP PDSCH, the UE receives/buffers PDSCH1-4 based on the determined two default beams (e.g., even if PDCCH1 and/or PDCCH2 schedules sTRP PDSCH, the UE receives/buffers PDSCH1-4 based on the determined two default beams). In some examples, a rationale (for the UE to receive/buffer PDSCH1-4 based on the determined two default beams, for example) may be that a number of TCI states indicated by beam indication DCI is 2 or for mTRP operation and when scheduling offset is smaller than a threshold, UE may need to receive/buffer PDSCHs first before decoding PDCCH (since the UE does not have sufficient time to decode PDCCH before receiving/buffering the PDSCHs, for example).

FIG. 10 provides a data structure 1006 indicative of the determined two default beams (e.g., the determined two TCI states) to use for PDSCH1, PDSCH2, PDSCH3, and/or PDSCH4 according to examples when (i) the beam indication DCI indicates TCI codepoint 4 (e.g., the determined two default beams may comprise TCI1 and TCI2), (ii) the beam indication DCI indicates TCI codepoint 5 (e.g., the determined two default beams may comprise TCIll and TCI12), (iii) the beam indication DCI indicates TCI codepoint 6 (e.g., the determined two default beams may comprise TCI11 and TCI12) and/or (iv) the beam indication DCI indicates TCI codepoint 7 (e.g., the determined two default beams may comprise TCI11 and TCI12).

In the example shown in the data structure 1004 of FIG. 10, for TCI codepoint 2, a DL/joint TCI (e.g., one DL/joint TCI) is associated with RS in the serving cell (e.g., PCI=x). For example, the TCI codepoint 2 may comprise merely the one DL/joint TCI (e.g., TCI13) associated with the serving cell. In some examples, regardless of whether or not the UE has capability to receive PDSCHs by two default beams and/or two default TCI states, when beam indication DCI indicates TCI codepoint 2, the UE may determine one default beam (rather than two default beams, for example). In the example shown in the data structure 1004, TCI codepoint 2 comprises TCI13. In some examples, based on TCI13 is associated with RS in serving cell (PCI=x), the one default beam is based on (e.g., comprises) TCI13. In another example (not shown) where TCI13 is associated with RS in additional cell and/or non-serving cell (e.g., PCy), the one default beam may be based on TCI state of a CORESET with a lowest CORESET index among one or more CORESETs in the latest slot associated with PDSCH (e.g., the latest slot associated with PDSCH may correspond to a last slot of one or more scheduled PDSCHs, such as a last slot of PDSCH1-4). When transmission(s) are scheduled according to the timing diagram 906 in FIG. 9, UE may determine default TCI state or default beam for receiving PDSCH1, PDSCH2, PDSCH3, and/or PDSCH4. When beam indication DCI indicates TCI codepoint associated with one DL/joint TCI state (e.g., TCI codepoint 2) and scheduling offset (e.g., the interval 908 between PDCCH2 and PDSCH1) is smaller than a threshold (e.g., the timedurationForQCL 910), the one default TCI state and/or the one default beam may be TCI13 (if TCI13 is associated with PCI=x, for example) or may be TCI of CORESET with lowest CORESET ID among one or more CORESETs in the latest slot of PDSCH (if TCI13 is associated with PCI=y, for example). In some examples, UE may receive PDSCH1-4 based on the one default beam and/or the one default TCI state.

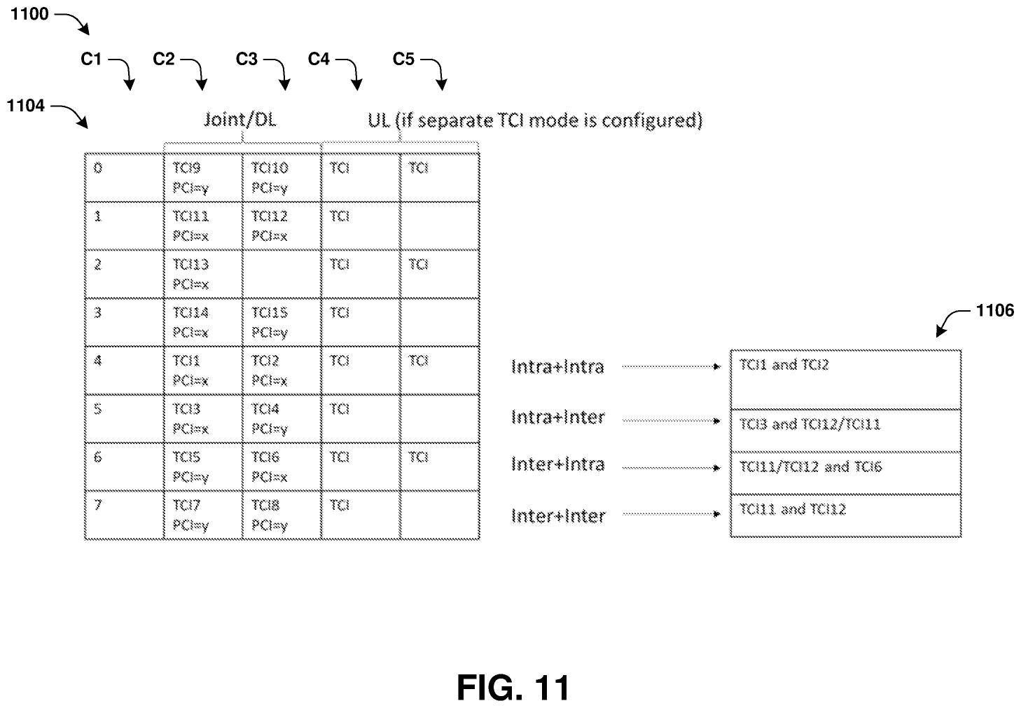

FIG. 11 illustrates an example scenario 1100 associated with a UE. FIG. 11 provides a data structure 1104 indicative of TCI codepoints (e.g., TCI codepoint indexes 0-7) in column C1, and TCI states associated with the TCI codepoints in columns C2, C3, C4 and C5 (e.g., columns C2 and C3 of the data structure 1104 may provide DL and/or joint TCI states, and/or columns C4 and C5 of the data structure may provide UL TCI states).

In some examples, in the example scenario 1100, PCI=x corresponds to a serving cell (e.g., the first cell), such as one serving cell, and PCI=y corresponds to an additional and/or non-serving cell (e.g., the second cell), such as one additional and/or non-serving cell.

For TCI codepoints 5˜6 (i.e., TCI codepoints with TCI codepoint indexes “5” and “6” in column C1 of the data structure 1104), at least one DL/joint TCI in each of TCI codepoints 5˜6 is associated with RS in the non-serving and/or additional cell. The UE may support receiving (e.g., may have capability to receive) PDSCHs by two default beam and/or two default TCI states. When transmission(s) are scheduled according to the timing diagram 906 in FIG. 9, UE may determine default TCI state or default beam for receiving PDSCH1, PDSCH2, PDSCH3, and/or PDSCH4. When scheduling offset (e.g., the interval 908 between PDCCH2 and PDSCH1) is smaller than a threshold (e.g., the timedurationForQCL 910) and beam indication DCI indicates at least one of TCI codepoint 5 or 6, the two default TCI states and/or the two default beams may not be fully determined based on TCI states in the TCI codepoint (e.g., TCI codepoint 5 or 6) indicated by the beam indication DCI (e.g., merely one default TCI state of the two default TCI states may be determined using the TCI codepoint 5 or 6 indicated by the beam indication DCI).

In some examples, a first default TCI state/beam of the two default TCI states and/or the two default beams is based on (e.g., comprises) a TCI state, indicated by beam indication DCI, associated with PCI=x. In some examples, in the data structure 1104 of FIG. 11, for TCI codepoint 5, TCI3 is used as the first default TCI state/beam (of the two default TCI states and/or the two default beams) to be used for receiving PDSCH (e.g., TC36 is used as the first default TCI state/beam based on the beam indication DCI being indicative of TCI codepoint 5, for example). In the present disclosure, the term “TCI state/beam” may refer to a TCI state and/or a beam. In some examples, in the data structure 1104 of FIG. 11, for TCI codepoint 6, TCI6 is used as the first default TCI state/beam (of the two default TCI states and/or the two default beams) to be used for receiving PDSCH (e.g., TCI6 is used as the first default TCI state/beam based on the beam indication DCI being indicative of TCI codepoint 6, for example).

In some examples, for TCI codepoint 5, a second default TCI state/beam (other than the first default TCI state/beam) of the two default TCI states and/or the two default beams (for receiving PDSCH, for example) is not TCI4 indicated by TCI codepoint 5 (even when the beam indication DCI indicates TCI codepoint 5, for example). In some examples, for TCI codepoint 5, the second default TCI state/beam for receiving PDSCH is based on (e.g., comprises) a lowest TCI codepoint which comprises a DL/joint TCI state (e.g., 2-nd DL/joint TCI state) associated with serving cell (e.g., PCI=x). In an example, TCI state 12 in TCI codepoint 1 may be used as the second default TCI state/beam for receiving PDSCH. Alternatively and/or additionally, the second default TCI state/beam for receiving PDSCH may be based on (e.g., may comprise) TCI state associated with CORESET with lowest CORESET ID among one or more CORESETs in the latest slot (of PDSCH, for example). Alternatively and/or additionally, the second default TCI state/beam for receiving PDSCH may be based on (e.g., may always be based on) a lowest TCI codepoint which comprises at least one DL/joint TCI state associated with serving cell (e.g., PCI=x) (e.g., the second default TCI state/beam for receiving PDSCH may be determined to be a DL/joint TCI state, associated with the serving cell, of a TCI codepoint with a lowest TCI codepoint index among one or more TCI codepoints, such as TCI codepoints 1, 2, 3, 4, 5 and 6, which include at least one DL/joint TCI state associated with the serving cell), and in an example, TCI state 11 in TCI codepoint 1 may be used as the second default TCI state/beam for receiving PDSCH (e.g., 1-st DL/joint TCI state is used if the lowest TCI codepoint comprises two DL/joint TCI states).

In some examples, for TCI codepoint 6, the second default TCI state/beam (other than the first default TCI state/beam) of the two default TCI states and/or the two default beams (for receiving PDSCH, for example) is not TCIS indicated by TCI codepoint 6 (even when the beam indication DCI indicates TCI codepoint 6, for example). In some examples, for TCI codepoint 6, the second default TCI state/beam for receiving PDSCH is based on (e.g., comprises) a lowest TCI codepoint which comprises a DL/joint TCI state (e.g., 1-st DL/joint TCI state) associated with serving cell (e.g., PCI=x). In an example, TCI state 11 in TCI codepoint 1 may be used as the second default TCI state/beam for receiving PDSCH. Alternatively and/or additionally, the second default TCI state/beam for receiving PDSCH may be based on (e.g., may comprise) TCI state associated with CORESET with lowest CORESET ID among one or more CORESETs in the latest slot (of PDSCH, for example). Alternatively and/or additionally, the second default TCI state/beam for receiving PDSCH may be based on (e.g., may always be based on) a lowest TCI codepoint which comprises at least one DL/joint TCI state associated with serving cell (e.g., PCI=x) (e.g., the second default TCI state/beam for receiving PDSCH may be determined to be a DL/joint TCI state, associated with the serving cell, of a TCI codepoint with a lowest TCI codepoint index among one or more TCI codepoints, such as TCI codepoints 1, 2, 3, 4, 5 and 6, which include at least one DL/joint TCI state associated with the serving cell), and in an example, TCI state 11 in TCI codepoint 1 may be used as the second default TCI state/beam for receiving PDSCH (e.g., 1-st DL/joint TCI state is used if the lowest TCI codepoint comprises two DL/joint TCI states). Alternatively and/or additionally, the second default TCI state/beam for receiving PDSCH may be based on (e.g., may always be based on) a lowest TCI codepoint which comprises at least one DL/joint TCI state associated with serving cell (e.g., PCI=x) (e.g., the second default TCI state/beam for receiving PDSCH may be determined to be a DL/joint TCI state, associated with the serving cell, of a TCI codepoint with a lowest TCI codepoint index among one or more TCI codepoints, such as TCI codepoints 1, 2, 3, 4, 5 and 6, which include at least one DL/joint TCI state associated with the serving cell), and in an example, TCI state 12 in TCI codepoint 1 may be used as the second default TCI state/beam for receiving PDSCH (e.g., 2-nd DL/joint TCI state is used if the lowest TCI codepoint comprises two DL/joint TCI states).

FIG. 11 provides a data structure 1106 indicative of the determined two default beams (e.g., the determined two TCI states) to use for PDSCH1, PDSCH2, PDSCH3, and/or PDSCH4 according to examples when (i) the beam indication DCI indicates TCI codepoint 4 (e.g., the determined two default beams may comprise TCI1 and TCI2), (ii) the beam indication DCI indicates TCI codepoint 5 (e.g., the determined two default beams may comprise TCI3 and TCI11 or TCI12), (iii) the beam indication DCI indicates TCI codepoint 6 (e.g., the determined two default beams may comprise TCI6 and TCI11 or TCI12) and/or (iv) the beam indication DCI indicates TCI codepoint 7 (e.g., the determined two default beams may comprise TCI11 and TCI12).

Alternatively and/or additionally, a network restriction (e.g., one network restriction) may be considered in which the network shall indicate TCI codepoint 0 associated with both DL/joint TCI states associated with serving cell (e.g., PCI=x). In some examples, a rationale is as TCI11 and TCI12 in TCI codepoint 1 are associated with serving cell (PCx), which UE may receive PDCCH in common search space or receive non-UE dedicated PDCCH (e.g., the UE may use TCI11 and/or TCI12 to receive PDCCH in common search space and/or receive non-UE dedicated PDCCH). In some examples, UE may receive PDSCH1-4 based on the two default beams and/or the two TCI states (as determined using one or more of the techniques provided herein, for example). In some examples, PDCCH1 and/or PDCCH2 in the timing diagram 906 of FIG. 9 may be a scheduling DCI for PDSCH (e.g., PDCCH1 and/or PDCCH2 may schedule PDSCH1, PDSCH2, PDSCH3, and/or PDSCH4). After decoding PDCCH1 and/or PDCCH2, even PDCCH1 and/or PDCCH2 schedules sTRP PDSCH, the UE receives/buffers PDSCH1-4 based on the determined two default beams (e.g., even if PDCCH1 and/or PDCCH2 schedules sTRP PDSCH, the UE receives/buffers PDSCH1-4 based on the determined two default beams). In some examples, a rationale (for the UE to receive/buffer PDSCH1-4 based on the determined two default beams, for example) may be that a number of TCI states indicated by beam indication DCI is 2 or UE may be in mTRP operation and when scheduling offset is smaller than a threshold, UE may need to receive/buffer PDSCHs first before decoding PDCCH (since the UE does not have sufficient time to decode PDCCH before receiving/buffering the PDSCHs, for example).

In some examples, in the present disclosure, a DL/joint TCI being associated with RS this means and/or implies that a type-D QCL assumption and/or a spatial filter for receiving channel/signal is associated with the RS (wherein the channel/signal, the type-D QCL assumption and/or the spatial filter are associated with the DL/joint TCI, for example). In some examples, QCL type-D assumption and/or spatial filter for receiving channel/signal may be based on type-D QCL assumption and/or spatial filter for receiving the RS.

In some examples, when the beam indication DCI indicates TCI codepoint, the UE may apply one or more TCI states of the TCI codepoint. In some examples, one, some and/or all instances of the present disclosure in which the beam indication DCI indications TCI codepoint may be replaced with (and/or supplemented with) an indication that the UE applied one or more TCI states of the TCI codepoint.

In some examples, a MAC CE for associating TCI codepoint and one or more TCI states (e.g., the MAC CE may indicate that the one or more TCI states are associated with, such as included in, the TCI codepoint) may comprise more than one TCI codepoint. In some examples, the UE may apply TCI state(s) according to a first beam indication DCI received in slot u. In some examples, the UE may receive a second beam indication DCI in slot n. In some examples, the second beam indication DCI may schedule one or more PDSCHs in slot m, m+1, . . . m+k. In some examples, the UE may transmit HARQ feedback (e.g., ACK) in response to the beam indication DCI and/or the one or more scheduled PDSCHs. In some examples, the UE may apply one or more TCI states, after (and/or in response to) the second beam indication DCI, in slot p. In some examples, a time order of slots u, n, m and m+k may be: slot u, followed by slot n, followed by slot m, followed by slot m+k, followed by slot p. In some examples, slot n may directly follow slot u (e.g., no other slot is between slots n and u) or there may be one or more other slots between slots n and u. In some examples, slot m may directly follow slot n (e.g., no other slot is between slots m and n) or there may be one or more other slots between slots m and n. In some examples, slot m+k may directly follow slot m (e.g., no other slot is between slots m+k and m) or there may be one or more other slots (e.g., slot m+1, etc.) between slots m+k and m. In some examples, slot p may directly follow slot m+k (e.g., no other slot is between slots p and m+k) or there may be one or more other slots between slots p and m+k. In some examples, before slot p, the UE may apply one or more TCI states based on the first beam indication DCI received in slot n. In some examples, in response to the first beam indication DCI, the UE applies one or more TCI states according to the first beam indication DCI. In some examples, in response to the second beam indication DCI, the UE applies one or more TCI states according to the second beam indication DCI (e.g., starting in slot p, the UE applies the one or more TCI states according to the second beam indication DCI).

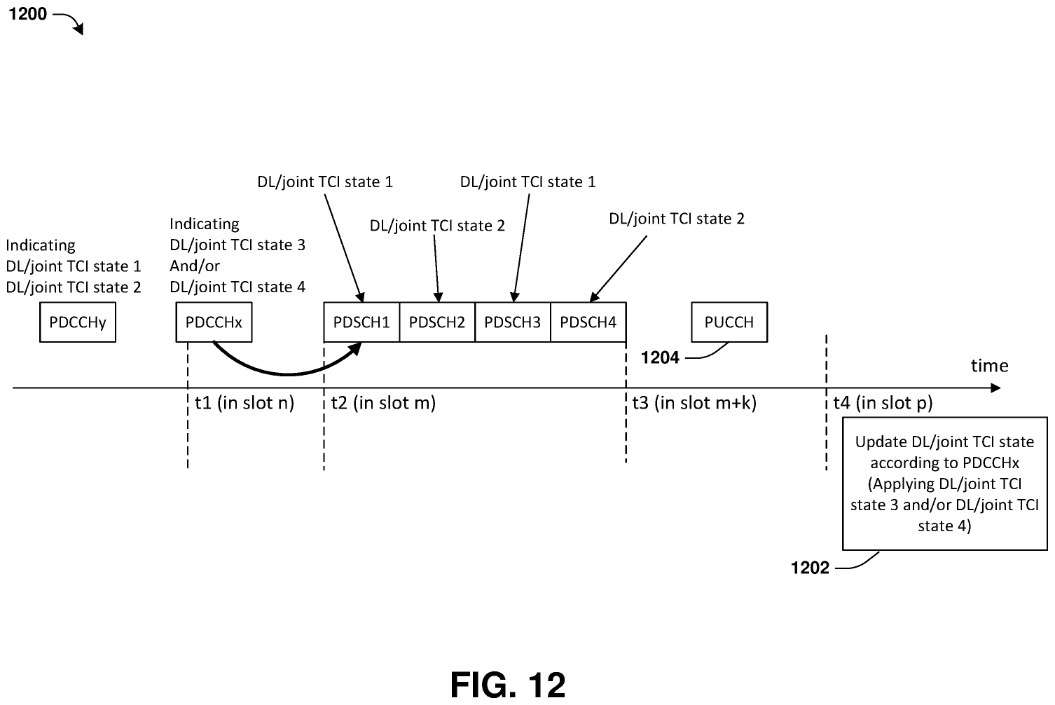

FIG. 12 illustrates an example scenario 1200 in which a UE receives PDCCHy indicating DL/joint TCI state 1 and/or DL/joint TCI state 2 (e.g., PDCCHy may comprise a beam indication DCI, such as the first beam indication DCI, for indicating DL/joint TCI state 1 and/or DL/joint TCI state 2). UE may apply DL/joint TCI state 1 and/or DL/joint TCI state 2 to receive PDCCHx at timing tl in slot n. In some examples, PDCCHx may be a beam indication DCI (e.g., the second beam indication DCI) indicating a TCI codepoint (e.g., different than a TCI codepoint associated with PDCCHy) comprising DL/joint TCI state 3 and/or DL/joint TCI state 4. In some examples, PDCCHx may schedule mTRP PDSCHs (e.g., PDSCH1˜4) between timing t2 (in slot m, for example) and timing t3 (in slot m+k, for example). In some examples, a scheduling offset between PDCCHx and the scheduled mTRP PDSCHs (e.g., PDSCH1˜4) is smaller than a threshold (e.g., the threshold may correspond to timedurationForQCL). In some examples, downlink assignment (e.g., at least one of time domain resource allocation, frequency domain resource allocation, HARQ process number, New Data Indicator (NDI), Downlink Assignment Index (DAI), etc.) except TCI field may be based on PDCCHx. For example, one or more downlink assignment parameters (e.g., at least one of time domain resource allocation, frequency domain resource allocation, HARQ process number, NDI, DAI, etc.) of the scheduled PDSCHs (e.g., PDSCH1˜4) may be based on PDCCHx. In some examples, UE receives PDSCH1˜4 based on DL/joint TCI statel and/or DL/joint TCI state2 according to PDCCHy (e.g., the UE does not use PDCCHx to determine which DL/joint TCI state(s) to use for the scheduled PDSCHs). In some examples, the UE applies 1202 one or more TCI states according to PDCCHy at timing t4 in slot p (e.g., starting in slot p, the UE applies the one or more TCI states according to PDCCHy). In some examples, slot p and/or timing t4 may be after (and/or when) a processing time has elapsed after transmission of HARQ feedback (e.g., ACK) on uplink transmission 1204 (e.g., PUCCH and/or PUSCH transmission) in response to PDCCHx (which schedules PDSCH1˜4).

In some examples, if a number of DL/joint TCI states indicated by the first beam indication DCI is one (e.g., DL/joint TCI state z), before slot p, the UE operates as single TRP (e.g., the UE may perform single TRP operation for receiving one or more transmissions before slot p) and/or the UE receives one or more PDSCHs (e.g., PDSCH1˜4) based on the one DL/joint TCI state z indicated by the first beam indication DCI. In some examples, if the number of DL/joint TCI states indicated by the second beam indication DCI is two (e.g., DL/joint TCI state g and DL/joint TCI state h), the UE may (still) operate as single TRP (e.g., the UE may (still) perform single TRP operation) (before slot p, for example), and/or the UE may receive one or more PDSCHs (e.g., PDSCH1˜4) based on the one DL/joint TCI state z. In some examples, before slot p, the UE does not apply one or more TCI states according to the second beam indication DCI (e.g., the UE does not apply one or more TCI states according to a number of TCI states indicated by the second beam indication DCI). In some examples, the UE receives one or more PDSCHs (e.g., PDSCH1˜4 shown in FIG. 12) in slots m . . . m+k based on the one DL/joint TCI state z (and/or may not use another DL/joint TCI state in addition to the one DL/joint TCI state z to receive the one or more PDSCHs in slots m . . . m+k). In some examples, after slot p, the UE may operate as multiple TRP or single TRP (e.g., the UE may perform multiple TRP operation in which a transmission is received using multiple TRPs or single TRP operation in which a transmission is received using a single TRP). In some examples, whether to apply one or two DL/joint TCI state indicated by the second beam indication DCI may be determined (e.g., derived) based on scheduling DCI. In some examples, scheduling DCI may indicate DL/joint TCI state g (e.g., sTRP), DL/joint TCI state h (e.g., sTRP), DL/joint TCI state g followed by DL/joint TCI state h (e.g., mTRP), and/or DL/joint TCI state h followed by DL/joint TCI state g (e.g., mTRP) for receiving one or more scheduled PDSCHs (e.g., PDSCH1˜4).

In some examples, if the number of DL/joint TCI states indicated by the first beam indication DCI is two (e.g., DL/joint TCI state g and DL/joint TCI state h), before slot p, the UE may operate as multiple TRP or single TRP (e.g., the UE may perform multiple TRP operation in which a transmission is received using multiple TRPs or single TRP operation in which a transmission is received using a single TRP). In some examples, whether to apply one or two DL/joint TCI states indicated by the first beam indication DCI may be determined (e.g., derived) based on scheduling DCI. In some examples, scheduling DCI may indicate DL/joint TCI state g (e.g., sTRP), DL/joint TCI state h (e.g., sTRP), DL/joint TCI state g followed by DL/joint TCI state h (e.g., mTRP), and/or DL/joint TCI state h followed by DL/joint TCI state g (e.g., mTRP) for receiving one or more scheduled PDSCHs (e.g., PDSCH1˜4). In some examples, if the number of DL/joint TCI states indicated by the second beam indication DCI is one (e.g., DL/joint TCI state z), the UE receives one or more PDSCHs based on the one DL/joint TCI state g or h (e.g., the UE may receive the one or more PDSCHs using one of DL/joint TCI state g or DL/joint TCI state h). In some examples, before slot p, the UE does not apply one or more TCI states according to the second beam indication DCI (e.g., the UE does not apply one or more TCI states according to a number of TCI states indicated by the second beam indication DCI). In some examples, the UE receives one or more PDSCHs in slots m . . . m+k based on the one DL/joint TCI state g or h and/or may not use another DL/joint TCI state in addition to the one DL/joint TCI state g or h to receive the one or more PDSCHs in slots m . . . m+k). In some examples, after slot p, the UE operates as single TRP (e.g., the UE may perform single TRP operation in which a transmission is received using a single TRP). In some examples, after slot p, the UE receives one or more PDSCHs based on DL/joint TCI state z.

In some examples, a MAC CE for associating TCI codepoint and one or more TCI states (e.g., the MAC CE may indicate that the one or more TCI states are associated with, such as included in, the TCI codepoint) may comprise one TCI codepoint (e.g., the MAC CE may comprise merely the one TCI codepoint). In some examples, the UE may receive the MAC CE in slot s. In some examples, the UE may apply one or more TCI states associated with the one TCI codepoint in slot t. In some examples, slot t is an earliest slot upon and/or after a processing time elapses after the UE transmits HARQ feedback (e.g., ACK) in response to the MAC CE. In some examples, the one TCI codepoint is associated with two DL/joint TCI states. In some examples, whether to receive one or more scheduled PDSCHs based on one or two DL/joint TCI states may be indicated by scheduling DCI (e.g., the scheduling DCI may indicate whether the UE shall use one DL/joint TCI state or two DL/joint TCI states for reception of the one or more scheduled PDSCHs).

In some examples, the scheduling offset corresponds to an interval between PDCCH and at least one of PDSCH, CSI-RS, PUSCH, PUCCH, Sounding Reference Signal (SRS), or Physical Random Access Channel (PRACH). For example, the scheduling offset may correspond to an interval from an ending symbol of PDCCH to a starting symbol of at least one of PDSCH, CSI-RS, PUSCH, PUCCH, SRS, or PRACH. In some examples, the scheduling offset (e.g., the interval) may include or may not include a starting symbol of at least one of PDSCH, CSI-RS, PUSCH, PUCCH, SRS, or PRACH. In some examples, the interval may include or may not include an ending symbol of PDCCH. In some examples, if there are two PDCCHs having the same DCI format (e.g., the two PDCCHs are received and/or monitored in different monitoring occasions), a latter PDCCH of the two PDCCHs (e.g., PDCCHx as opposed to PDCCHy in FIG. 12) may be used as a reference PDCCH for determining the scheduling offset. In some examples, the two PDCCHs are linked to each other based on at least search space linking (e.g., the two PDCCHs may each be associated with the same link ID). In some examples, if there are more than one scheduled PDSCHs, a first scheduled PDSCH (e.g., an earliest PDSCH of the scheduled PDSCHs) is used as a reference PDCCH for determining the scheduling offset. In an example, the scheduling offset corresponds to an interval between the latter PDCCH and the earliest scheduled PDSCH.

The UE may have RRC establishment with the first cell (e.g., an RRC connection is established between the UE and the first cell and/or the UE performs an RRC connection establishment procedure with the first cell). The UE may receive a configuration for the first cell. In some examples, the UE does not have RRC establishment with the second cell (e.g., an RRC connection is not established between the UE and the second cell and/or the UE does not perform an RRC connection establishment procedure with the second cell). Information associated with the second cell may be provided by the first cell. In some examples, the UE determines the information associated with the second cell based on RRC Information Element (IE) SSB-MTC-AdditionalPC1 (e.g., the SSB-MTC-AdditionalPC1 IE may be associated with synchronization signal block (SSB) measurement). In some examples, the UE determines information associated with the first cell based on System Information Block (SIB), Master Information Block (MIB), and/or dedicated RRC configuration associated with (e.g., from) the first cell. In some examples, the second cell does not have a corresponding serving cell index. In some examples, the first cell has a corresponding serving cell index. In some examples, for carrier aggregation in a cell group, serving cell index is from 0 to 15. In some examples, for dual connectivity, serving cell index is from 0 to 31. In some examples, the first cell, the serving cell and/or cell with PCI=x may correspond to a cell without configuring additionalPClindex (e.g., a cell that is not configured with additionalPClindex). In some examples, additionalPCI index is from 1-7. In some examples, the second cell, the additional cell, the non-serving cell and/or the cell with PCI=y may refer to a cell with configuring additionalPClindex (e.g., one additionalPClindex) (e.g., a cell that is configured with additionalPClindex).

In some examples, for scheduling offset being smaller than a threshold, the UE receives/buffers one or more PDSCHs/CSI-RSs based on the one or two default beams (e.g., in response to the scheduling offset being smaller than the threshold, the UE receives/buffers the one or more PDSCHs/CSI-RSs based on the one or two default beams determined using one or more of the techniques provided herein). In some examples, beam may be replaced by DL/joint TCI state and/or DL/joint TCI state may be replaced by beam. In some examples, determination of the one or two default beams determination may be performed using any combination of one or more of the techniques provided herein (with respect to Concept A, for example).

### Concept B

In Concept B, when UE is indicated with a first DL/joint TCI state and a second DL/joint TCI state (e.g., when the UE is provided with an indication, such as a beam indication DCI, indicating the first DL/joint TCI state and the second DL/joint TCI state) and a scheduling offset (e.g., an interval between a PDCCH and a scheduled PDSCH) is smaller than a threshold, the UE may determine a default beam (e.g., one default beam) based on a TCI state, among the first DL/joint TCI state and the second DL/joint TCI state, that is associated with serving cell (e.g., a first cell). A second cell is with a different PCI than the first cell (e.g., the serving cell). The second cell may be associated with an additionalPCllndex which is a value (e.g., one integer value) from at least 1 to at most 7. In some examples, the UE does not support having two default beams for multiple TRP operation (e.g., the UE does not have capability to have two default beams for multiple TRP operation). For example, the UE may not be configured with enable TwoDefaultTCI-States and/or enable TwoDefaultTCI-States may not be enabled for the UE).

In some examples, when both the first DL/joint TCI state and the second DL/joint TCI state are associated with the first cell, a 1-st TCI state in TCI codepoint is determined to be the default beam (e.g., the one default beam) (e.g., the first DL/joint TCI is determined to be the default beam if the first DL/joint TCI state is 1-st DL/joint TCI state in the TCI codepoint or the second DL/joint TCI is determined to be the default beam if the second DL/joint TCI state is 1-st DL/joint TCI state in the TCI codepoint).

Alternatively and/or additionally, when both the first and second DL/joint TCI state are associated with the first cell, a TCI state having a lower TCI state ID among the first DL/joint TCI state and the second DL/joint TCI state is determined to be the default beam (e.g., the one default beam).

Alternatively and/or additionally, when both the first and second DL/joint TCI state are associated with the first cell, a TCI state having a higher TCI state ID among the first DL/joint TCI state and the second DL/joint TCI state is determined to be the default beam (e.g., the one default beam).

Alternatively and/or additionally, when both the first DL/joint TCI state and the second DL/joint TCI state are associated with the first cell, a TCI state with CORESETPoolIndex=0 is determined to be the default beam (e.g., the one default beam) (e.g., the first DL/joint TCI is determined to be the default beam if the first DL/joint TCI state is 1-st DL/joint TCI state in the TCI codepoint or the second DL/joint TCI is determined to be the default beam if the second DL/joint TCI state is 1-st DL/joint TCI state in the TCI codepoint).

In some examples, when the first DL/joint TCI state is associated with the serving cell and the second DL/joint TCI state is associated with the second cell (e.g., non-serving cell), the UE determines the default beam (e.g., the one default beam) based on the first DL/joint TCI state (e.g., the UE determines the first DL/joint TCI state to be the default beam if the first DL/joint TCI state is associated with the serving cell and the second DL/joint TCI state is associated with the second cell).

In some examples, when the second DL/joint TCI state is associated with the serving cell and the first DL/joint TCI state is associated with the second cell (e.g., non-serving cell), the UE determines the default beam (e.g., the one default beam) based on the second DL/joint TCI state (e.g., the UE determines the second DL/joint TCI state to be the default beam if the second DL/joint TCI state is associated with the serving cell and the first DL/joint TCI state is associated with the second cell).

In some examples, when both the first DL/joint TCI state and the second DL/joint TCI state are associated with the second cell (e.g., additional and/or non-serving cell), the UE determines the default beam (e.g., the one default beam) based on TCI state associated with a CORESET with a lowest CORESET ID among one or more CORESETs in latest slot (of PDSCH, for example) (e.g., the one or more CORESETs may be monitored by the UE in the latest slot of the scheduled PDSCH, for example).

Alternatively and/or additionally, in Concept B, when UE is indicated with a first DL/joint TCI state and a second DL/joint TCI state (e.g., when the UE is provided with an indication, such as a beam indication DCI, indicating the first DL/joint TCI state and the second DL/joint TCI state) and a scheduling offset (e.g., an interval between a PDCCH and a scheduled PDSCH) is smaller than a threshold, wherein the first DL/joint TCI state and/or the second DL/joint TCI state are associated with RS in the second cell (e.g., additional and/or non-serving cell), the UE may determine the default beam (e.g., the one default beam) based on TCI state of CORESET with a lowest CORESET ID among one or more CORESETs in latest slot (of PDSCH, for example) (e.g., the one or more CORESETs may be monitored by the UE in the latest slot of the scheduled PDSCH, for example).

In some examples, the UE applies two DL/joint TCI states of TCI codepoint according to beam indication DCI. In some examples, the beam indication DCI is delivered by a third PDCCH. The UE may receive UE-dedicated PDCCH and/or PDSCH reception based on the two DL/joint TCI states. The UE may monitor a second CORESET and/or a second PDCCH based on a DL/joint TCI state (e.g., one DL/joint TCI state) of the two DL/joint TCI states. The UE may monitor a first CORESET and/or a first PDCCH based on a DL/joint TCI state (e.g., one DL/joint TCI state) of the two DL/joint TCI states. Alternatively and/or additionally, the UE may monitor the first CORESET and/or the first PDCCH based on a third DL/joint TCI state associated with the first CORESET. The third DL/joint TCI state may be different from each of the two DL/joint TCI states. In some examples, the first CORESET is associated with UE-dedicated signal/channel. In some examples, the second CORESET is associated with non-UE-dedicated signal/channel.

In some examples, the UE may be configured with one or more serving cells comprising the first cell and a third cell (e.g., the one or more serving cells may not comprise the second cell).

In some examples, the UE may receive UE-dedicated PDSCH/PDCCH on the first cell and/or the third cell based on DL/joint TCI state indicated by beam indication DCI.

In some examples, the first cell and the third cell may be in same frequency band.

In some examples, one TCI codepoint is associated with two DL/joint TCI states. In some examples, 1-st DL/joint TCI state of the two DL/joint TCI states is associated with a lower octet index than 2-nd DL/joint TCI state of the two DL/joint TCI states. In some examples, both a DL/joint TCI state associated with octet index i and a DL/joint TCI state associated with index j are associated with (e.g., included in) one TCI codepoint. In some examples, if i is smaller than j, 1-st DL/joint TCI state for the one TCI codepoint is DL/joint TCI state associated with octet index i and 2-nd DL/joint TCI state for the one TCI codepoint is DL/joint TCI state associated with octet index j.

In some examples, MAC CE is used for associating one or more TCI states and TCI codepoint. In some examples, MAC CE is used for associating one or more TCI states and TCI codepoint (e.g., the MAC CE may indicate that the TCI codepoint is associated with the one or more TCI states), wherein the TCI codepoint may be used for indicating a TCI state for receiving UE-dedicated PDCCH (e.g., the one or more TCI states associated with the TCI codepoint may be used for receiving UE-dedicated PDCCH). In some examples, the TCI codepoint is used for indicating TCI state for transmitting UE-dedicated Physical Uplink Shared Channel (PUSCH)/Physical Uplink Control Channel (PUCCH). In some examples, the UE is not provided with another MAC CE that is used for associating TCI state and TCI codepoint for PDSCH (e.g., merely for PDSCH).

In some examples, DCI format 1_1 in the first CORESET does not comprise TCI field (e.g., one or more DCIs, in the first CORESET, that correspond to DCI format 1_1 do not comprise TCI field).

In some examples, DCI format 1_2 in the first CORESET does not comprise TCI field (e.g., one or more DCIs, in the first CORESET, that correspond to DCI format 1_2 do not comprise TCI field).

In some examples, DCI format 1_1 in the first CORESET comprises TCI field (e.g., one or more DCIs, in the first CORESET, that correspond to DCI format 1_1 comprise TCI field).

In some examples, DCI format 1_2 in the first CORESET comprises TCI field (e.g., one or more DCIs, in the first CORESET, that correspond to DCI format 1_2 comprise TCI field).

In some examples, DCI format 1_1 in the second CORESET does not comprise TCI field (e.g., one or more DCIs, in the second CORESET, that correspond to DCI format 1_1 do not comprise TCI field).

In some examples, DCI format 1_2 in the second CORESET does not comprise TCI field (e.g., one or more DCIs, in the second CORESET, that correspond to DCI format 1_2 do not comprise TCI field).

In some examples, DCI format 1_1 in the second CORESET comprises TCI field (e.g., one or more DCIs, in the second CORESET, that correspond to DCI format 1_1 comprise TCI field).

In some examples, DCI format 1_2 in the second CORESET comprises TCI field (e.g., one or more DCIs, in the second CORESET, that correspond to DCI format 1_2 comprise TCI field).

In some examples, a MAC CE for associating TCI codepoint and one or more TCI states (e.g., the MAC CE may indicate that the one or more TCI states are associated with, such as included in, the TCI codepoint) may comprise up to M TCI codepoint(s) and/or N TCI state(s). In some examples, MAC CE may comprise one TCI codepoint (e.g., M=1). In some examples, MAC CE may comprise a plurality of TCI codepoint (e.g., M >1). In some examples, the N TCI state(s) may comprise DL/joint TCI state(s) and/or UL TCI state(s). In some examples, each TCI state of the N TCI state(s) may comprises a DL TCI state, a joint TCI state and/or a UL TCI state. In some examples, a TCI codepoint (e.g., one TCI codepoint) may be associated with (e.g., the TCI codepoint may comprise) up to 2 DL/joint TCI states and/or up to 2 UL TCI states.

In some examples, the scheduling offset corresponds to an interval between PDCCH and at least one of PDSCH, CSI-RS, PUSCH, PUCCH, SRS, or PRACH. For example, the scheduling offset may correspond to an interval from an ending symbol of PDCCH to a starting symbol of at least one of PDSCH, CSI-RS, PUSCH, PUCCH, SRS, or PRACH. In some examples, the scheduling offset (e.g., the interval) may include or may not include a starting symbol of at least one of PDSCH, CSI-RS, PUSCH, PUCCH, SRS, or PRACH. In some examples, the interval may include or may not include an ending symbol of PDCCH. In some examples, if there are two PDCCHs having the same DCI format (e.g., the two PDCCHs are received and/or monitored in different monitoring occasions), a latter PDCCH of the two PDCCHs (e.g., PDCCHx as opposed to PDCCHy in FIG. 12) may be used as a reference PDCCH for determining the scheduling offset. In some examples, the two PDCCHs are linked to each other based on at least search space linking (e.g., the two PDCCHs may each be associated with the same link ID). In some examples, if there are more than one scheduled PDSCHs, a first scheduled PDSCH (e.g., an earliest PDSCH of the scheduled PDSCHs) is used as a reference PDCCH for determining the scheduling offset. In an example, the scheduling offset corresponds to an interval between the latter PDCCH and the earliest scheduled PDSCH.

The UE may have RRC establishment with the first cell (e.g., an RRC connection is established between the UE and the first cell and/or the UE performs an RRC connection establishment procedure with the first cell). The UE may receive a configuration for the first cell. In some examples, the UE does not have RRC establishment with the second cell (e.g., an RRC connection is not established between the UE and the second cell and/or the UE does not perform an RRC connection establishment procedure with the second cell). Information associated with the second cell may be provided by the first cell. In some examples, the UE determines the information associated with the second cell based on RRC IE SSB-MTC-AdditionalPCI (e.g., the SSB-MTC-AdditionalPCI IE may be associated with synchronization signal block (SSB) measurement). In some examples, the UE determines information associated with the first cell based on SIB, MIB, and/or dedicated RRC configuration associated with (e.g., from) the first cell. In some examples, the second cell does not have a corresponding serving cell index. In some examples, the first cell has a corresponding serving cell index. In some examples, for carrier aggregation in a cell group, serving cell index is from 0 to 15. In some examples, for dual connectivity, serving cell index is from 0 to 31. In some examples, the first cell, the serving cell and/or cell with PCI=x may correspond to a cell without configuring additionalPCIindex (e.g., a cell that is not configured with additionalPCIindex). In some examples, additionalPCI index is from 1˜7. In some examples, the second cell, the additional cell, the non-serving cell and/or the cell with PCI=y may refer to a cell with configuring a additionalPCIindex (e.g., one additionalPCIindex) (e.g., a cell that is configured with additionalPCIindex).

In some examples, for scheduling offset being smaller than a threshold, the UE receives/buffers one or more PDSCHs/CSI-RSs based on the one or two default beams (e.g., in response to the scheduling offset being smaller than the threshold, the UE receives/buffers the one or more PDSCHs/CSI-RSs based on the one or two default beams determined using one or more of the techniques provided herein). In some examples, beam may be replaced by DL/joint TCI state and/or DL/joint TCI state may be replaced by beam. In some examples, determination of the one or two default beams determination may be performed using any combination of one or more of the techniques provided herein (with respect to Concept A, for example).

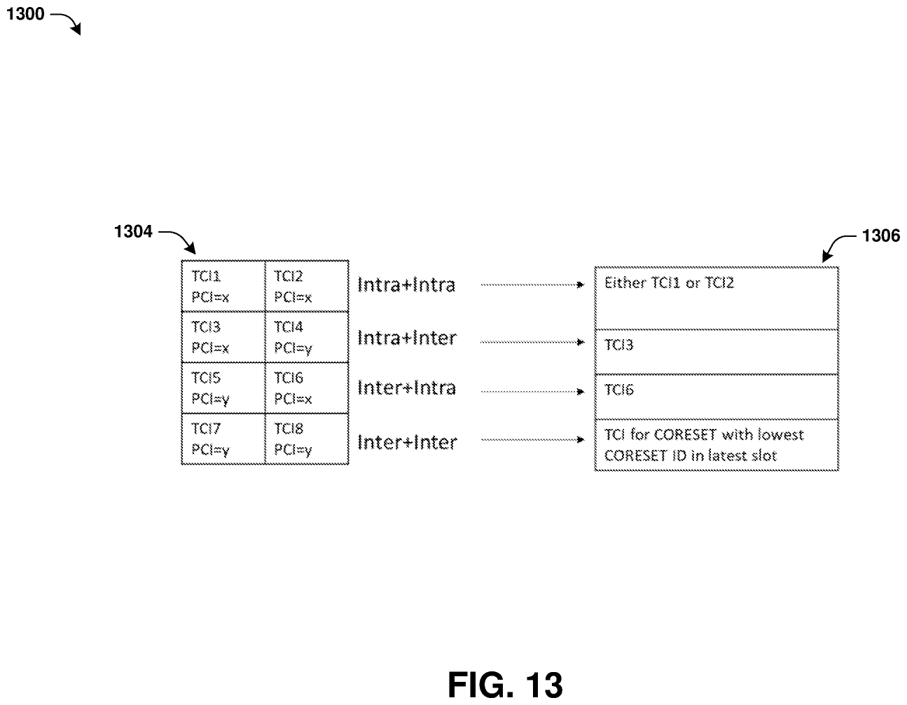

FIG. 13 illustrates an example scenario 1300 associated with a UE. FIG. 13 provides a data structure 1304 indicative of TCI states and a data structure 1306 indicative of determined beams (e.g., determinations of the one default beam) to use for a scheduled PDSCH, for example. In the example scenario 1300, PCI=x corresponds to a serving cell (e.g., the first cell), such as one serving cell, and PCI=y corresponds to an additional and/or non-serving cell (e.g., the second cell), such as one additional and/or non-serving cell. In some examples, each TCI state of TCI1˜8 is a DL/joint TCI state. In some examples, the UE may not support receiving/buffering (e.g., may not have capability to receive/buffer) PDSCH based on two default beams/TCI states (e.g., the UE may determine and/or use merely one default beam to use for receiving the scheduled PDSCH).

In some examples, when a beam indication DCI indicates a TCI codepoint associated with TCI1 and TCI2 and the scheduling offset is smaller than a threshold, the UE may determine one default TCI state (to use for the scheduled PDSCH, for example) based on either TCI1 or TCI2 (e.g., the UE may use either TCI1 or TCI2 for the scheduled PDSCH since both TCI1 and TCI2 are associated with the serving cell).

In some examples, when the beam indication DCI indicates a TCI codepoint associated with TCI3 and TCI4 and scheduling offset is smaller than a threshold, the UE may determine one default TCI state based on TCI3 which is associated with (i) serving cell (PCI=x), (ii) a cell without configuring additionalPCIindex (e.g., a cell that is not configured with additionalPCIindex), and/or (iii) a cell with configuring servingcell index (e.g., a cell configured with a serving cell index). For example, the UE may use TCI3 for the scheduled PDSCH.

In some examples, when the beam indication DCI indicates a TCI codepoint associated with TCI5 and TCI6 and scheduling offset is smaller than a threshold, the UE may determine one default TCI state based on TCI6 which is associated with (i) serving cell (PCI=x), (ii) a cell without configuring additionalPCIindex (e.g., a cell that is not configured with additionalPCIindex), and/or (iii) a cell with configuring servingcell index (e.g., a cell configured with a serving cell index). For example, the UE may use TCI3 for the scheduled PDSCH.

In some examples, when the beam indication DCI indicates a TCI codepoint associated with TCI7 and TCI8 and scheduling offset is smaller than a threshold, the UE may determine one default TCI state based on TCI state of CORESET with lowest CORESET ID among one or more CORESETs in the latest slot (of PDSCH, for example) (e.g., the one or more CORESETs may be monitored by the UE in the latest slot of the scheduled PDSCH, for example).

One, some and/or all of the foregoing examples, concepts, techniques and/or embodiments can be formed and/or combined to a new embodiment.

In some examples, embodiments disclosed herein, such as embodiments described with respect to Concept A and Concept B, may be implemented independently and/or separately. Alternatively and/or additionally, a combination of embodiments described herein, such as embodiments described with respect to Concept A and/or Concept B, may be implemented. Alternatively and/or additionally, a combination of embodiments described herein, such as embodiments described with respect to Concept A and/or Concept B, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

With respect to one or more embodiments herein, such as one or more techniques, devices, concepts, methods, example scenarios and/or alternatives described above, in some examples, the first cell, the serving cell and/or the cell with PCI=x may correspond to a cell without configuring additionalPCIindex (e.g., a cell that is not configured with additionalPCIindex). In some examples, the second cell, the additional cell, the non-serving cell and/or the cell with PCI=y may refer to a cell with configuring additionalPCIindex (e.g., one additionalPCIindex) (e.g., a cell that is configured with additionalPCIindex).

With respect to one or more embodiments herein, in some examples, when the UE determines a beam and/or TCI state based on a DL/joint TCI state (of a TCI codepoint, for example), the UE determines the beam and/or TCI state to comprise the DL/joint TCI state. For example, in the present disclosure, the UE determining a default beam and/or TCI state for a scheduled PDSCH based on a DL/joint TCI state may correspond to the UE determining to use the DL/joint TCI state as the default beam and/or TCI state for the scheduled PDSCH.

In some examples, in the present disclosure, one, some and/or all instances of the term “when” may be replaced and/or supplemented with “if”, “based on”, and/or “in response to”. For example, a statement “when the first DL/joint TCI state is associated with the serving cell and the second DL/joint TCI state is associated with the second cell, the UE determines the default beam based on the first DL/joint TCI state” may provide for (i) the UE using the first DL/joint TCI state to determine the default beam if the first DL/joint TCI state is associated with the serving cell and the second DL/joint TCI state is associated with the second cell, (ii) the UE using the first DL/joint TCI state to determine the default beam based on the first DL/joint TCI state being associated with the serving cell and the second DL/joint TCI state being associated with the second cell, and/or (iii) the UE using the first DL/joint TCI state to determine the default beam in response to the first DL/joint TCI state being associated with the serving cell and the second DL/joint TCI state being associated with the second cell.

In some examples, in the present disclosure, one, some and/or all instances of the term “TCI state” may be replaced and/or supplemented with “beam”. In some examples, in the present disclosure, one, some and/or all instances of the term “beam” may be replaced and/or supplemented with “TCI state”.

In some examples, in the present disclosure, one, some and/or all instances of the term “TCI” may be replaced and/or supplemented with “TCI state”. In some examples, in the present disclosure, one, some and/or all instances of the term “TCI state” may be replaced and/or supplemented with “TCI”.

In some examples, in the present disclosure, one, some and/or all instances of the term “defined” may be replaced and/or supplemented with “default” and/or “specific”. In some examples, in the present disclosure, one, some and/or all instances of the term “default” may be replaced and/or supplemented with “defined”.

In some examples, although some examples of the present disclosure are associated with two TCI states and/or two beams (e.g., two default TCI states and/or beams), it may be appreciated that the quantity “two” may be changed to a different quantity (e.g., any quantity such as three, four, etc.). In some examples, TCI states and/or beams (e.g., three default TCI states and/or beams if the different quantity is three) may be determined according to the different quantity using one or more of the techniques provided herein with respect to the quantity “two” and/or “one”.

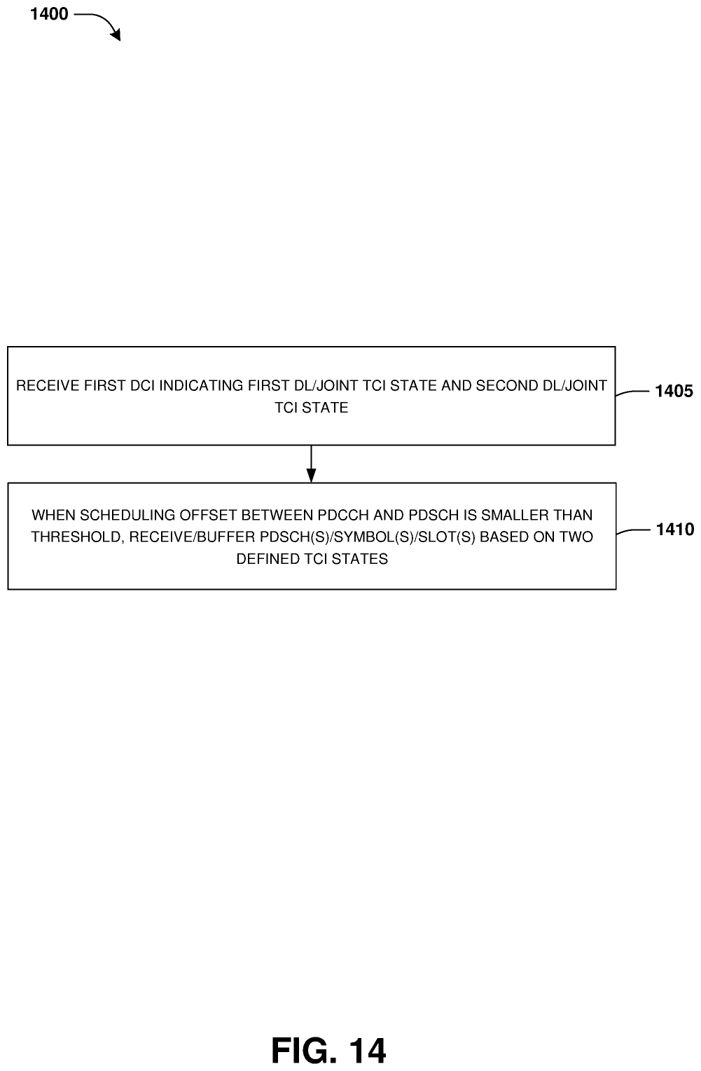

FIG. 14 is a flow chart 1400 according to one exemplary embodiment from the perspective of a UE in a wireless communication system. In step 1405, the UE receives a first DCI indicating a first DL/joint TCI state and a second DL/joint TCI state. The first DCI may be a beam indication DCI. In step 1410, when a scheduling offset between PDCCH and PDSCH is smaller than a threshold, the UE receives/buffers PDSCH(s)/symbol(s)/slot(s) based on two defined (e.g., default and/or specific) TCI states.

In the present disclosure, the term “PDSCH(s)/symbol(s)/slot(s)” may refer to one or more PDSCHs, one or more symbols (e.g., one or more symbols associated with a PDSCH) and/or one or more slots (e.g., one or more slots associated with a PDSCH).

In one embodiment, the two defined TCI states are determined when a number of DL/joint TCI states associated with the first DCI (e.g., the beam indication DCI) is at least two (e.g., the number of DL/joint TCI states may correspond to a number of DL/joint TCI states applied and/or indicated according to the first DCI).

In one embodiment, when the number of DL/joint TCI states associated with the first DCI (e.g., the beam indication DCI) is smaller than two (e.g., when the number of DL/joint TCI states associated with the first DCI is one), the UE determines one defined TCI state for receiving/buffering PDSCH(s)/symbol(s)/slot(s).

In one embodiment, each DL/joint TCI state (e.g., each DL/joint TCI state of at least one of the first DL/joint TCI state, the second DL/joint TCI state, a DL/join TCI state indicated by the first DCI, etc.) may be associated with (e.g., may comprise) at least one RS for QCL type-D assumption, and/or the one RS may be associated with a first cell or a second cell, and/or the one RS is in the first cell or the second cell.

In one embodiment, the first cell is associated with (e.g., configured with) a serving cell index (e.g., the first cell is a serving cell), and/or the first cell is not associated with an index (e.g., additionalPCIindex) for configuring additionalPCI.

In one embodiment, the second cell is not associated with (e.g., is not configured with) serving cell index (e.g., the second cell is not the serving cell), and/or the second cell is associated with an index (e.g., additionalPCIindex) for configuring additionalPCI, and/or the second cell is a non-serving cell, and/or the second cell is an additional cell.

In one embodiment, when at least one RS associated with the first DL/joint TCI state and/or the second DL/joint TCI state is associated with the second cell, the two defined TCI states are based on (e.g., the two defined TCI states comprise) one or more DL/joint TCI states in a TCI codepoint with a lowest TCI codepoint index among TCI codepoints comprising two DL/joint TCI states (e.g., the two defined TCI states are based on one or more DL/joint TCI states in a TCI codepoint with a lowest TCI codepoint index among TCI codepoints which each comprise two DL/joint TCI states).

In one embodiment, two DL/joint TCI states in the TCI codepoint with the lowest TCI codepoint index are both associated with RS associated with the first cell (e.g., none of the two DL/joint TCI states in the TCI codepoint with the lowest TCI codepoint index are associated with the second cell).

In one embodiment, the UE does not expect that none of one or more TCI codepoints in a MAC CE comprise two DL/joint TCI states that are (both) associated with RS in the first cell, and/or the UE expects that at least one TCI codepoint in a MAC CE comprises two DL/joint TCI states that are (both) associated with RS in the first cell.

In one embodiment, when RS associated with the first DL/joint TCI state and RS associated with the second DL/joint TCI state are (both) associated with the first cell, the two defined TCI states are based on (e.g., the two defined TCI states comprise) the first DL/joint TCI state and the second DL/joint TCI state.

In one embodiment, when RS associated with the first DL/joint TCI state and RS associated with the second DL/joint TCI state are (both) associated with the second cell, the two defined TCI states are based on (e.g., the two defined TCI states comprise) one or more DL/joint TCI states in a TCI codepoint with a lowest TCI codepoint index among TCI codepoints comprising two DL/joint TCI states (e.g., the two defined TCI states are based on one or more DL/joint TCI states in a TCI codepoint with a lowest TCI codepoint index among TCI codepoints which each comprise two DL/joint TCI states).

In one embodiment, two DL/joint TCI states in the TCI codepoint with the lowest TCI codepoint index are both associated with RS associated with the first cell (e.g., none of the two DL/joint TCI states in the TCI codepoint with the lowest TCI codepoint index are associated with the second cell).

In one embodiment, when RS associated with the first DL/joint TCI state is associated with the first cell and RS associated with the second DL/joint TCI state is associated with the second cell, at least a first one of the two defined TCI states is based on (e.g., comprises) the first DL/joint TCI state, and a second one of the two defined TCI states may be the same as or different than the first one of the two defined TCI states.

In one embodiment, for the second one of the two defined TCI states different than the first one of the two defined TCI states, the second one of the two defined TCI states may be based on (e.g., the second one of the two defined TCI states may comprise) (i) DL/joint TCI state associated with a CORESET with a lowest CORESET index among one or more CORESETs in a slot (e.g., a latest and/or most recent slot, such as a latest and/or most recent slot comprising PDSCH), (ii) a DL/joint TCI state in TCI codepoint with lowest TCI codepoint index among TCI codepoints comprising two DL/joint TCI states (e.g., second one of the two defined TCI states is based on a DL/joint TCI state in a TCI codepoint with a lowest TCI codepoint index among TCI codepoints which each comprise two DL/joint TCI states), wherein a RS in the DL/joint TCI state in the TCI codepoint (e.g., the second one of the two defined TCI states comprises the DL/joint TCI state) is associated with the first cell, and/or (iii) a 2-nd DL/joint TCI state in TCI codepoint with lowest TCI codepoint index among TCI codepoints comprising two DL/joint TCI states (e.g., second one of the two defined TCI states is based on a DL/joint TCI state in a TCI codepoint with a lowest TCI codepoint index among TCI codepoints which each comprise two DL/joint TCI states), wherein a RS in the 2-nd DL/joint TCI state is associated with the first cell.

In one embodiment, for the second one of the two defined TCI states being same as the first one of the two defined TCI states, the UE may determine one defined (e.g., default) TCI state (e.g., the UE may merely determine the one defined TCI state instead of two defined TCI states), and/or the UE receives/buffers one or more PDSCHs based on the one default TCI state (regardless of mTRP repetition, number of TCI states indicated by the first DCI, and/or mTRP scheme, for example).

In one embodiment, the UE receives one or more MAC CEs for associating TCI states and TCI codepoints, and/or the one or more MAC CEs are used for unified TCI state, and/or the one or more MAC CEs are used for at least one of UE-specific PDCCH, UE-specific PDSCH, UE-specific PUCCH, UE-specific PUSCH, UE-specific SRS, UE-specific CSI-RS, etc.

In one embodiment, once the UE is configured with unified TCI, the UE does not receive MAC CE (e.g., PDSCH-specific MAC CE) for associating TCI state and TCI codepoint for PDSCH.

In one embodiment, the UE supports receiving DL channel and/or signal based on the two defined TCI states. For example, the UE has capability to receive and/or is configured to receive DL channel and/or signal based on the two defined TCI states (e.g., the UE supports using the two defined TCI states to receive the DL channel and/or signal).

In one embodiment, the UE receives UE-specific DL channel and/or signal based on the first DL/joint TCI state and the second DL/joint TCI state.

In one embodiment, the UE is configured with the first mTRP operation mechanism (e.g., sDCI mTRP) and/or the UE receives one DCI scheduling mTRP PDSCHs.

In one embodiment, the UE is configured with the second mTRP operation mechanism (e.g., mDCI mTRP). In some examples, the UE receives DCI from CORESET with CORESETPoolIndex=0 (e.g., first TRP), wherein the DCI schedules PDSCH associated with first TRP. In some examples, the UE receives one or more other DCIs from CORESET with CORESETPoolIndex=1 (e.g., second TRP), wherein the one or more other DCIs schedule PDSCH associated with second TRP.

In one embodiment, if the UE receives a second DCI indicating the same first DL/joint TCI state and the same second DL/joint TCI state, the UE does not update one or more applied DL/joint TCI states (e.g., the UE continues to apply DL/joint TCI state(s) according to the first DCI).

In one embodiment, if the UE receives a third DCI indicating a third DL/joint TCI state and a fourth DL/joint TCI state, the UE updates one or more applied DL/joint TCI states (e.g., the UE updates the one or more applied DL/joint TCI states from being based on the first DCI to being based on the second DCI) after a first timing (e.g., slot p).

Referring back to FIGS. 3 and 4, in one exemplary embodiment of a UE in a wireless communication system, the device 300 includes a program code 312 stored in the memory 310. The CPU 308 may execute program code 312 to enable the UE (i) to receive a first DCI indicating a first DL/joint TCI state and a second DL/joint TCI state, and (ii) when a scheduling offset between PDCCH and PDSCH is smaller than a threshold, to receive/buffer PDSCH(s)/symbol(s)/slot(s) based on two defined TCI states. Furthermore, the CPU 308 can execute the program code 312 to perform one, some and/or all of the above-described actions and steps and/or others described herein.

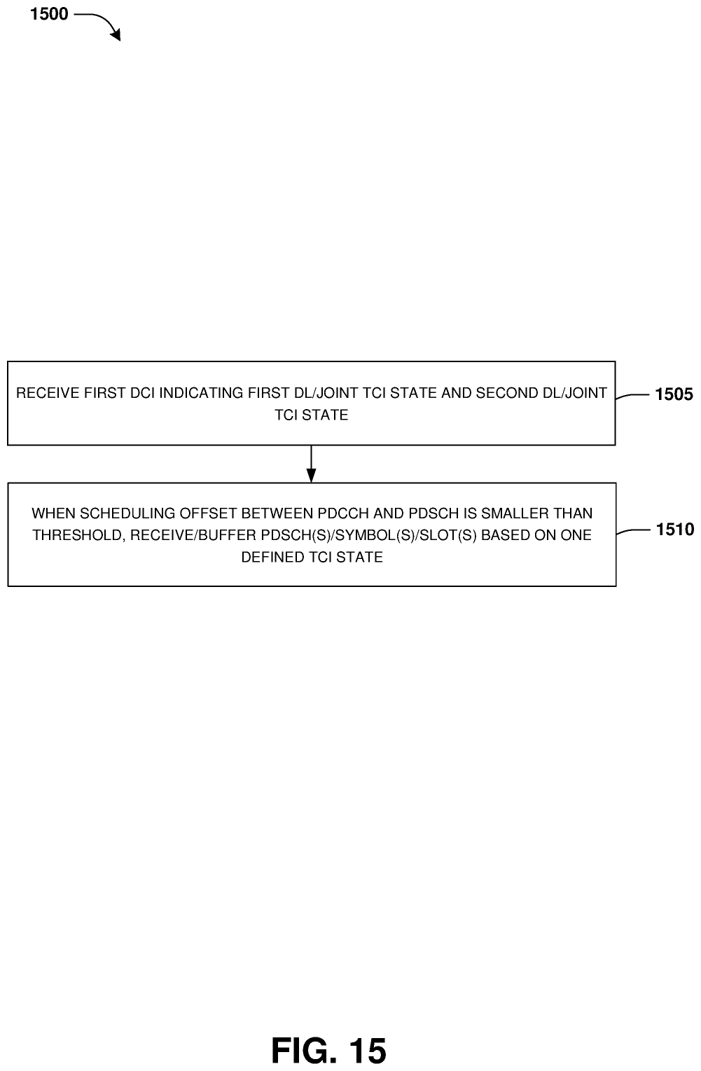

FIG. 15 is a flow chart 1500 according to one exemplary embodiment from the perspective of a UE in a wireless communication system. In step 1505, the UE receives a first DCI indicating a first DL/joint TCI state and a second DL/joint TCI state. The first DCI may be a beam indication DCI. In step 1510, when a scheduling offset between PDCCH and PDSCH is smaller than a threshold, the UE receives/buffers PDSCH(s)/symbol(s)/slot(s) based on one defined (e.g., default and/or specific) TCI state.

In one embodiment, (e.g., each DL/joint TCI state of at least one of the first DL/joint TCI state, the second DL/joint TCI state, a DL/join TCI state indicated by the first DCI, etc.) may be associated with (e.g., may comprise) at least one RS for QCL type-D assumption, and/or the one RS may be associated with (e.g., may be in) a first cell or a second cell.

In one embodiment, the first cell is associated with (e.g., configured with) a serving cell index (e.g., the first cell a serving cell), and/or the first cell is not associated with an index (e.g., additionalPCIindex) for configuring additionalPCI.

In one embodiment, the second cell is not associated with (e.g., is not configured with) serving cell index (e.g., the second cell is not the serving cell), and/or the second cell is associated with an index (e.g., additionalPCIindex) for configuring additionalPCI, and/or the second cell is a non-serving cell, and/or the second cell is an additional cell.

In one embodiment, when RS associated with the first DL/joint TCI state and RS associated with the second DL/joint TCI state are (both) associated with the first cell, the one defined TCI state is based on (e.g., the one defined TCI state comprises) the first DL/joint TCI state, which may be an initial (e.g., 1-st) DL/joint TCI state in a TCI codepoint.

In one embodiment, the one defined TCI state is based on (e.g., the one defined TCI state comprises) DL/joint TCI state(s) in a TCI codepoint with a lowest TCI codepoint index among TCI codepoints comprising at least one DL/joint TCI state with RS associated with the first cell (e.g., the one defined TCI state is based on one or more DL/joint TCI states in a TCI codepoint with a lowest TCI codepoint index among TCI codepoints which each comprise at least one DL/joint TCI state with RS associated with the first cell).

In one embodiment, when RS associated with the first DL/joint TCI state and RS associated with the second DL/joint TCI state are (both) associated with the second cell, the one defined TCI state is based on (e.g., the one defined TCI state comprises) DL/joint TCI state(s) in a TCI codepoint with a lowest TCI codepoint index among TCI codepoints comprising at least one DL/joint TCI state with RS associated with the first cell (e.g., the one defined TCI state is based on one or more DL/joint TCI states in a TCI codepoint with a lowest TCI codepoint index among TCI codepoints which each comprise at least one DL/joint TCI state with RS associated with the first cell).

In one embodiment, when RS associated with the first DL/joint TCI state is associated with the first cell and RS associated with the second DL/joint TCI state is associated with the second cell, the one defined TCI state is based on (e.g., the one defined TCI state comprises) a DL/joint TCI state, of the first DL/joint TCI state or the second DL/joint TCI state, that is associated with a RS associated with the first cell (e.g., thus the one defined TCI state is based on, such as comprises, the first DL/joint TCI state since RS associated with the first DL/joint TCI state is associated with the first cell).

In one embodiment, the one defined TCI state is based on (e.g., the one defined TCI state comprises) DL/joint TCI state of a CORESET with a lowest CORESET index among one or more CORESETs in a slot (e.g., a latest and/or most recent slot, such as a latest and/or most recent slot comprising PDSCH).

In one embodiment, when RS associated with the first DL/joint TCI state and RS associated with the second DL/joint TCI state are (both) associated with the second cell, the one defined TCI state is based on (e.g., the one defined TCI state comprises) DL/joint TCI state of a CORESET with a lowest CORESET index among one or more CORESETs in a slot (e.g., a latest and/or most recent slot, such as a latest and/or most recent slot comprising PDSCH).

In one embodiment, the UE receives one or more MAC CEs for associating TCI states and TCI codepoints, and/or the one or more MAC CEs are used for unified TCI state, and/or the one or more MAC CEs are used for at least one of UE-specific PDCCH, UE-specific PDSCH, UE-specific PUCCH, UE-specific PUSCH, UE-specific SRS, UE-specific CSI-RS, etc.

In one embodiment, once the UE is configured with unified TCI, the UE does not receive MAC CE (e.g., PDSCH-specific MAC CE) for associating TCI state and TCI codepoint for PDSCH.

In one embodiment, the UE does not support receiving DL channel and/or signal based on the two defined TCI states. For example, the UE does not have capability to receive and/or is not configured to receive DL channel and/or signal based on the two defined TCI states (e.g., the UE does not support using the two defined TCI states to receive the DL channel and/or signal).

In one embodiment, the UE receives UE-specific DL channel and/or signal based on the first DL/joint TCI state and the second DL/joint TCI state.

In one embodiment, the UE is configured with the first mTRP operation mechanism (e.g., sDCI mTRP) and/or the UE receives one DCI scheduling mTRP PDSCHs.

In one embodiment, the UE is configured with the second mTRP operation mechanism (e.g., mDCI mTRP). In some examples, the UE receives DCI from CORESET with CORESETPoolIndex=0 (e.g., first TRP), wherein the DCI schedules PDSCH associated with first TRP. In some examples, the UE receives one or more other DCIs from CORESET with CORESETPoolIndex=1 (e.g., second TRP), wherein the one or more other DCIs schedule PDSCH associated with second TRP.

In one embodiment, if the UE receives a second DCI indicating the same first DL/joint TCI state and the same second DL/joint TCI state, the UE does not update one or more applied DL/joint TCI states (e.g., the UE continues to apply DL/joint TCI state(s) according to the first DCI).

In one embodiment, if the UE receives a third DCI indicating a third DL/joint TCI state and a fourth DL/joint TCI state, the UE updates one or more applied DL/joint TCI states (e.g., the UE updates the one or more applied DL/joint TCI states from being based on the first DCI to being based on the second DCI) after a first timing (e.g., slot p),In one embodiment, a PDCCH for determining the scheduling offset between PDCCH and PDSCH may be associated with the first DCI, the second DCI or the third DCI. In an example in which the PDCCH is associated with the first DCI, the scheduling offset may correspond to an interval between the PDCCH associated with the first DCI and the PDSCH.

Referring back to FIGS. 3 and 4, in one exemplary embodiment of a UE in a wireless communication system, the device 300 includes a program code 312 stored in the memory 310. The CPU 308 may execute program code 312 to enable the UE (i) to receive a first DCI indicating a first DL/joint TCI state and a second DL/joint TCI state, and (ii) when a scheduling offset between PDCCH and PDSCH is smaller than a threshold, to receive/buffer PDSCH(s)/symbol(s)/slot(s) based on one defined TCI state. Furthermore, the CPU 308 can execute the program code 312 to perform one, some and/or all of the above-described actions and steps and/or others described herein.

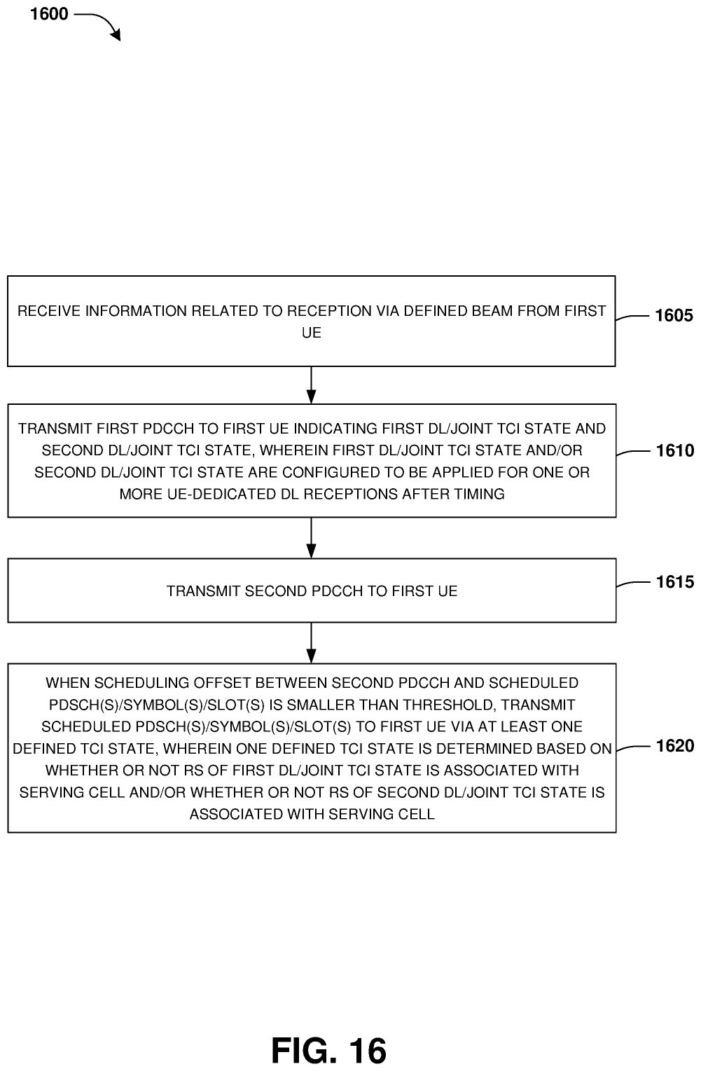

FIG. 16 is a flow chart 1600 according to one exemplary embodiment from the perspective of a network node in a wireless communication system. In step 1605, the network node receives information related to reception via a defined (e.g., default) beam (e.g., one defined beam) from a first UE. In step 1610, the network node transmits a first PDCCH to the first UE indicating a first DL/joint TCI state and a second DL/joint TCI state, wherein the first DL/joint TCI state and/or the second DL/joint TCI state are configured to be applied for one or more UE-dedicated DL receptions after (e.g., starting from) a timing. In step 1615, the network node transmits a second PDCCH to the first UE. In step 1620, when a scheduling offset between the second PDCCH and scheduled PDSCH(s)/symbol(s)/slot(s) is smaller than a threshold, the network node transmits the scheduled PDSCH(s)/symbol(s)/slot(s) to the first UE via at least one defined (e.g., default and/or specific) TCI state, wherein the one defined TCI state is determined based on whether or not a RS of the first DL/joint TCI state is associated with a serving cell and/or whether or not a RS of the second DL/joint TCI state is associated with the serving cell. In some examples, the scheduled PDSCH(s)/symbol(s)/slot(s) is scheduled by the second PDCCH.

In one embodiment, the first DL/joint TCI state may be associated with (e.g., may comprise) at least one RS for QCL type-D assumption, and/or the one RS is associated with a first cell or a second cell, and/or the one RS is in either the first cell or the second cell, and/or the second DL/joint TCI state may be associated with (e.g., may comprise) at least one RS for QCL type-D assumption, and/or the one RS is associated with a first cell or a second cell, and/or the one RS is in either the first cell or the second cell.

In one embodiment, the first cell is (configured) with serving cell index (which is a serving cell, for example), and/or the first cell is not associated with an index (additionalPCIindex) for configuring additionalPCI.

In one embodiment, the second cell is not (configured) with serving cell index, and/or the second cell is associated with an index (e.g., additionalPCIindex) for configuring additionalPCI, and/or the second cell is non-serving cell, and/or the second cell is an additional cell.

In one embodiment, when both RS associated with the first and the second DL/joint TCI state are associated with the first cell, the one defined TCI states is (based on) the first DL/joint TCI state which is 1-st DL/joint TCI state in a TCI codepoint.

In one embodiment, when both RS associated with the first and the second DL/joint TCI state are associated with the first cell, the one defined TCI states is (based on) TCI state with lower TCI state ID among the first DL/joint TCI state and the second DL/joint TCI state.

In one embodiment, when RS associated with the first DL/joint TCI state is associated with the first cell and RS associated with the second DL/joint TCI state is associated with the second cell, the one defined TCI state is (based on) a TCI state, of the first DL/joint TCI state and the second DL/joint TCI state, which is associated with a RS that is associated with the first cell (i.e., the one default TCI state is determined to be the first DL/joint TCI state).

In one embodiment, when RS associated with the first DL/joint TCI state is associated with the first cell and RS associated with the second DL/joint TCI state is associated with the second cell, the one defined TCI state is (based on) DL/joint TCI state of CORESET with lowest CORESET ID among one or more CORESETs in the latest slot (of PDSCH, for example).

In one embodiment, when both RS associated with the first and the second DL/joint TCI state are associated with the second cell, the one defined TCI state is (based on) one or more DL/joint TCI states in a TCI codepoint with lowest TCI codepoint index among TCI codepoints comprising at least one DL/joint TCI state with RS associated with the first cell.

In one embodiment, when both RS associated with the first and the second DL/joint TCI state are associated with the second cell, the one defined TCI state is (based on) DL/joint TCI state of CORESET with lowest CORESET ID among one or more CORESETs in the latest slot (of PDSCH, for example).

In one embodiment, the network node receives information related to reception via two default beams from a second UE. The network node transmits, to the second UE, a third PDCCH indicating a third DL/joint TCI state and a fourth DL/joint TCI state (which are to be applied for at least UE-dedicated DL reception starting from a second timing, for example). The network node transmits a fourth PDCCH to the second UE. The network node transmits scheduled PDSCH(s)/symbol(s)/slot(s) (e.g., the scheduled PDSCH(s)/symbol(s)/slot(s) may be scheduled by the fourth PDCCH) to the second UE via two defined TCI states. For example, the network node may transmit the scheduled PDSCH(s)/symbol(s)/slot(s) when a scheduling offset between the fourth PDCCH and the scheduled PDSCH(s)/symbol(s)/slot(s) is smaller than a threshold,.

In one embodiment, the two defined TCI states comprise the third DL/joint TCI state and the fourth DL/joint TCI state regardless of whether or not a RS of the third DL/joint TCI state and/or a RS of the fourth DL/joint TCI state are associated with serving cell.

In one embodiment, the two defined TCI state are determined based on whether or not RS of the third DL/joint TCI state and/or RS of the fourth DL/joint TCI state are associated with serving cell.

In one embodiment, the two defined TCI states comprise the third DL/joint TCI state and the fourth DL/joint TCI state when RS associated with the third DL/joint TCI state and RS associated with the fourth DL/joint TCI state are associated with the first cell.

In one embodiment, the two defined TCI states comprise the third DL/joint TCI state and the fourth DL/joint TCI state when RS associated with the third DL/joint TCI state or RS associated with the fourth DL/joint TCI state is associated with the first cell.

In one embodiment, when none of RS associated with the first DL/joint TCI state and RS associated with the second DL/joint TCI state are associated with the first cell, the two defined TCI states are determined based on TCI codepoint with lowest TCI codepoint among TCI codepoints comprising two TCI states with RS associated with the first cell.

In one embodiment, when none of RS associated with the first DL/joint TCI state and RS associated with the second DL/joint TCI state are associated with the first cell, the two defined TCI states are determined based on TCI codepoint with lowest TCI codepoint among TCI codepoints comprising two TCI states (and/or one TCI state) with at least one RS associated with the first cell.

Referring back to FIGS. 3 and 4, in one exemplary embodiment of a network node in a wireless communication system, the device 300 includes a program code 312 stored in the memory 310. The CPU 308 may execute program code 312 to enable the network node (i) to receive information related to reception via one defined beam from a first UE, (ii) to transmit a first PDCCH to the first UE indicating a first DL/joint TCI state and a second DL/joint TCI state, wherein the first DL/joint TCI state and/or the second DL/joint TCI state are configured to be applied for one or more UE-dedicated DL receptions after a timing, (iii) to transmit a second PDCCH to the first UE, and (iv) when a scheduling offset between the second PDCCH and scheduled PDSCH(s)/symbol(s)/slot(s) is smaller than a threshold, to transmit the scheduled PDSCH(s)/symbol(s)/slot(s) to the first UE via at least one defined TCI state, wherein the one defined TCI state is determined based on whether or not a RS of the first DL/joint TCI state is associated with a serving cell and/or whether or not a RS of the second DL/joint TCI state is associated with the serving cell. Furthermore, the CPU 308 can execute the program code 312 to perform one, some and/or all of the above-described actions and steps and/or others described herein.

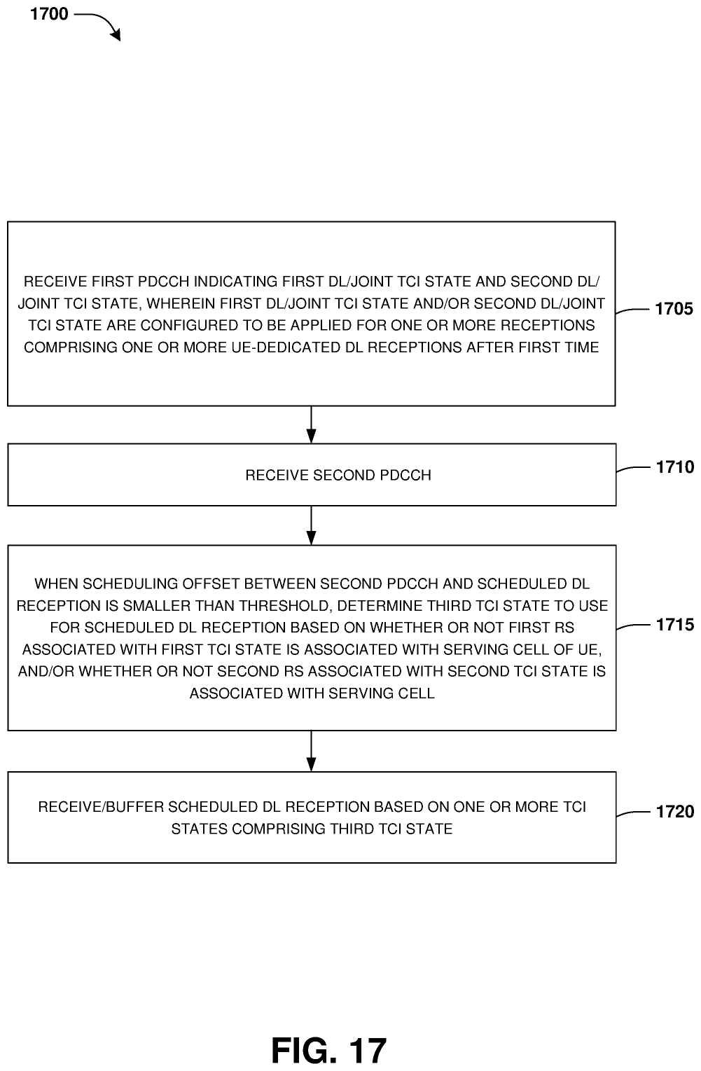

FIG. 17 is a flow chart 1700 according to one exemplary embodiment from the perspective of a UE in a wireless communication system. In step 1705, the UE receives a first PDCCH indicating a first DL/joint TCI state and a second DL/joint TCI state. The first DL/joint TCI state and/or the second DL/joint TCI state may be configured to be applied for one or more receptions comprising one or more UE-dedicated DL receptions (and/or one or more other receptions in addition to the one or more UE-dedicated DL receptions, for example) after a first time. For example, application of the first DL/joint TCI state and/or the second DL/joint TCI state may start from the first time (e.g., the first time may correspond to a start time for application of the first DL/joint TCI state and/or the second DL/joint TCI state to perform one or more receptions, such as the one or more UE-dedicated DL receptions). In step 1710, the UE receives a second PDCCH. In step 1715, when a scheduling offset between the second PDCCH and a scheduled DL reception is smaller than a threshold (e.g., the threshold may correspond to timedurationForQCL), the UE determines a third TCI state (e.g., a DL/joint TCI state) to use for the scheduled DL reception based on (i) whether or not a first RS associated with the first DL/joint TCI state is associated with a serving cell of the UE, and/or (ii) whether or not a second RS associated with the second DL/joint TCI state is associated with the serving cell. In some examples, the third TCI state corresponds to a defined TCI state (e.g., a default and/or specific TCI state) used by the UE to receive the scheduled DL reception. In some examples, the scheduled DL reception comprises one or more DL transmissions (e.g., one or more DL channels and/or signals) from a network to the UE (e.g., the scheduled DL reception may comprise one or more slots and/or one or more symbols of the one or more DL transmissions by the network). In some examples, the scheduled DL reception (e.g., the one or more DL transmissions) is scheduled by the second PDCCH. In an example, the scheduled DL reception (e.g., the one or more DL transmissions) may comprise one or more PDSCHs (e.g., one or more scheduled PDSCHs). In step 1720, the UE receives/buffers the scheduled DL reception based on one or more TCI states comprising the third TCI state. For example, the one or more TCI states may be used by the network to transmit the one or more DL transmissions (e.g., the network may transmit the one or more DL transmissions using one or more beams corresponding to the one or more TCI states). The UE may use the one or more TCI states to receive/buffer the one or more DL transmissions (e.g., the UE may successfully receive the one or more DL transmissions using the one or more beams corresponding to the one or more TCI states). In some examples, the one or more TCI states corresponds to one or more defined TCI states (e.g., one or more default and/or specific TCI states) used by the UE to receive the scheduled DL reception.

In some examples, the scheduling offset corresponds to an interval between the second PDCCH and the scheduled DL reception. For example, the scheduling offset (e.g., the interval) may extend from an ending symbol of the second PDCCH to a starting symbol of the scheduled DL reception. In some examples, the scheduling offset (e.g., the interval) may include or may not include the starting symbol of the scheduled DL reception. In some examples, the scheduling offset (e.g., the interval) may include or may not include the ending symbol of the second PDCCH.

In one embodiment, the UE does not support receiving a DL reception (e.g., a channel and/or a signal) based on two TCI states (e.g., the UE does not have capability and/or is not configured to receive a DL reception, such as the scheduled DL reception, using two TCI states). In some examples, the UE does not support having two TCI states (e.g., two default TCI states) for multiple TRP operation (e.g., the UE does not have capability and/or is not configured to have two default TCI states for performing multiple TRP operation). In some examples, the UE does not support concurrently using two TCI states (e.g., two default TCI states) to receive a DL reception (e.g., a channel and/or a signal) and/or for performing multiple TRP operation (e.g., the UE does not have capability and/or is not configured to concurrently use two default TCI states for receiving a DL reception). In some examples, the UE supports having merely one TCI state (e.g., one default TCI state) for receiving a DL reception.

In one embodiment, the first RS and the second RS are associated with QCL type-D assumption.

In one embodiment, the first RS is associated with a first cell (e.g., the serving cell) or a second cell (e.g., the first RS is either in the first cell or in the second cell).

In one embodiment, the second RS is associated with the first cell or the second cell (e.g., the first RS is either in the first cell or in the second cell).

In one embodiment, (i) a DL/joint TCI state (e.g., each DL/joint TCI state of the first DL/joint TCI state and/or the second DL/joint TCI state) is associated with (e.g., comprises) at least one RS for QCL type-D assumption, and/or (ii) the one RS is associated with the first cell or the second cell (e.g., the one RS is either in the first cell or in the second cell).

In one embodiment, the serving cell (e.g., the first cell) is associated with (e.g., configured with) a serving cell index.

In one embodiment, the serving cell (e.g., the first cell) is not associated with (e.g., not configured with) an index (e.g., additionalPCIindex) for configuring an additional PCI (e.g., additionalPCI).

In one embodiment, the second cell is not associated with (e.g., not configured with) a serving cell index.

In one embodiment, the second cell is associated with an index (e.g., additionalPCIindex) for configuring an additional PCI (e.g., additionalPCI).

In one embodiment, the second cell is a non-serving cell.

In one embodiment, the second cell is an additional cell.

In one embodiment, the first RS is associated with the serving cell and the second RS is associated with the serving cell. The third TCI state is determined based on the first DL/joint TCI state (e.g., the UE determines the third TCI state to be the first TCI state), wherein the first DL/joint TCI state corresponds to a DL/joint TCI state in a TCI codepoint. In some examples, the UE determines the third TCI state based on the first DL/joint TCI state (e.g., the UE determines the third TCI state to be the first TCI state) based on (e.g., in response to) (i) the first RS associated with the first DL/joint TCI state being associated with the serving cell, (ii) the UE not supporting receiving a DL reception (e.g., a channel and/or a signal) based on two TCI states, and/or (iii) the first DL/joint TCI state being a 1-st DL/joint TCI state in the TCI codepoint (e.g., the TCI codepoint may be included in the first PDCCH and/or may indicate the first DL/joint TCI state and/or the second DL/joint TCI state). In some examples, the first DL/joint TCI state may be determined to be the 1-st DL/joint TCI state in the TCI codepoint based on a determination that a position of the first DL/joint TCI state in the TCI codepoint is at least one of above, preceding, before, earlier than, followed by, etc. a position of the second DL/joint TCI state in the TCI codepoint. In some examples, the first DL/joint TCI state may be determined to be the 1-st DL/joint TCI state in the TCI codepoint based on a determination that an octet index of an octet of the first DL/joint TCI state indicated by the TCI codepoint is lower than an octet index of an octet of a different DL/joint TCI state (e.g., the second DL/joint TCI state) indicated by the TCI codepoint.

In one embodiment, the first RS is associated with the serving cell and the second RS is associated with the serving cell. The third TCI state is determined based on a TCI state, of the first DL/joint TCI state and the second DL/joint TCI state, that has a lowest TCI state ID among a first TCI state ID associated with the first DL/joint TCI state and a second TCI state ID associated with the second DL/joint TCI state. For example, the UE may determine the third TCI state to be the TCI state (of the first DL/joint TCI state and the second DL/joint TCI state) that has the lowest TCI state ID among the first TCI state ID associated with the first DL/joint TCI state and the second TCI state ID associated with the second DL/joint TCI state. In some examples, the UE determines the third TCI state based on the DL/joint TCI state having the lowest TCI state ID based on (e.g., in response to) (i) the first RS and the second RS associated with the first DL/joint TCI state and the second DL/joint TCI state being associated with the serving cell, and/or (ii) the UE not supporting receiving a DL reception (e.g., a channel and/or a signal) based on two TCI states.

In one embodiment, the first RS is associated with the serving cell and the second RS is associated with the second cell. The third TCI state is determined based on the first DL/joint TCI state in response to the first RS being associated with the serving cell. In some examples, the UE determines the third TCI state based on the first DL/joint TCI state based on (e.g., in response to) (i) the first RS associated with the first DL/joint TCI state being associated with the serving cell, (ii) the second RS associated with the second DL/joint TCI state being associated with the second cell, and/or (iii) the UE not supporting receiving a DL reception (e.g., a channel and/or a signal) based on two TCI states.

In one embodiment, the second RS is associated with the serving cell and the first RS is associated with the second cell. The third TCI state is determined based on the second DL/joint TCI state in response to the second RS being associated with the serving cell. In some examples, the UE determines the third TCI state based on the second DL/joint TCI state based on (e.g., in response to) (i) the second RS associated with the second DL/joint TCI state being associated with the serving cell, (ii) the first RS associated with the first DL/joint TCI state being associated with the second cell, and/or (iii) the UE not supporting receiving a DL reception (e.g., a channel and/or a signal) based on two TCI states.

In one embodiment, the first RS is associated with the serving cell and the second RS is associated with a second cell, and the third TCI state is determined based on a TCI state of a first CORESET with a lowest CORESET ID among one or more CORESET IDs of one or more CORESETs in one or more slots. For example, the UE may determine the third TCI state to be the TCI state of the first CORESET (with the lowest CORESET ID). In some examples, the one or more slots comprise (e.g., comprise merely) a latest slot of the DL reception. In some examples, the latest slot of the DL reception corresponds to a latest and/or most recent slot of the DL reception (e.g., a latest and/or most recent slot comprising at least a portion of a last PDSCH of the DL reception). In some examples, the UE monitors the one or more CORESETs (comprising the first CORESET) in the one or more slots (e.g., the latest slot of the DL reception). In some examples, the UE determines the third TCI state based on the TCI state of the first CORESET based on (e.g., in response to) (i) the first RS associated with the first DL/joint TCI state being associated with the serving cell, (ii) the second RS associated with the second DL/joint TCI state being associated with the second cell, and/or (iii) the UE not supporting receiving a DL reception (e.g., a channel and/or a signal) based on two TCI states.

In one embodiment, the first RS is associated with the second cell and the second RS is associated with the second cell. The third TCI state is determined based on a TCI state in a first TCI codepoint with a lowest TCI codepoint index among TCI codepoints (e.g., the UE may be configured with the TCI codepoints) comprising at least one DL/joint TCI state that is associated with a RS associated with the serving cell. For example, the UE may determine the third TCI state to be the TCI state of the first TCI codepoint (with the lowest TCI codepoint index). For example, each TCI codepoint of the TCI codepoints may comprise at least one DL/joint TCI state that is associated with a RS associated with the serving cell (e.g., each TCI codepoint of the TCI codepoints comprises a DL/joint TCI state that is associated with a RS in the serving cell). In some examples, the UE determines the third TCI state based on the TCI state of the first TCI codepoint based on (e.g., in response to) (i) the first RS associated with the first DL/joint TCI state being associated with the second cell, (ii) the second RS associated with the second DL/joint TCI state being associated with the second cell, (iii) the UE not supporting receiving a DL reception (e.g., a channel and/or a signal) based on two TCI states, (iv) the first TCI codepoint having the lowest TCI codepoint index among TCI codepoint indexes of the TCI codepoints, and/or (v) the TCI state of the first TCI codepoint being associated with a RS associated with the serving cell.

In one embodiment, the first RS is associated with the second cell and the second RS is associated with the second cell, and the third TCI state is determined based on a TCI state of a second CORESET with a lowest CORESET ID among one or more CORESET IDs of one or more CORESETs in one or more slots. For example, the UE may determine the third TCI state to be the TCI state of the second CORESET (with the lowest CORESET ID). In some examples, the one or more slots comprise (e.g., comprise merely) a latest slot of the DL reception. In some examples, the latest slot of the DL reception corresponds to a latest and/or most recent slot of the DL reception (e.g., a latest and/or most recent slot comprising at least a portion of a last PDSCH of the DL reception). In some examples, the UE monitors the one or more CORESETs (comprising the second CORESET) in the one or more slots (e.g., the latest slot of the DL reception). In some examples, the UE determines the third TCI state based on the TCI state of the second CORESET based on (e.g., in response to) (i) the first RS associated with the first DL/joint TCI state being associated with the second cell, (ii) the second RS associated with the second DL/joint TCI state being associated with the second cell, and/or (iii) the UE not supporting receiving a DL reception (e.g., a channel and/or a signal) based on two TCI states.

In one embodiment, based on the UE supporting receiving a DL reception (e.g., a channel and/or a signal) based on two TCI states (e.g., the UE has capability and/or is configured to receive a DL reception, such as the scheduled DL reception, using two TCI states), the one or more TCI states used to receive/buffer the scheduled DL reception comprise two TCI states. For example, if the UE supports receiving a DL reception based on two TCI states, the one or more TCI states used to receive/buffer the scheduled DL reception may comprise two TCI states regardless of whether or not the scheduling offset is smaller than the threshold.

In one embodiment, the one or more TCI states used to receive/buffer the scheduled DL reception comprise the first DL/joint TCI state and the second DL/joint TCI state, wherein the first RS and/or the second RS are associated with the serving cell.

In one embodiment, based on the first RS and/or the second RS being associated with the serving cell, the one or more TCI states used to receive/buffer the scheduled DL reception comprise the first DL/joint TCI state and the second DL/joint TCI state.

In one embodiment, based on the first RS and the second RS both being associated with the serving cell, the one or more TCI states used to receive/buffer the scheduled DL reception comprise the first DL/joint TCI state and the second DL/joint TCI state.

In one embodiment, the one or more TCI states used to receive/buffer the scheduled DL reception are determined based on a second TCI codepoint with a lowest TCI codepoint index among TCI codepoints (e.g., the UE may be configured with the TCI codepoints) comprising two TCI states associated with a RS associated with the serving cell, wherein the first RS is not associated with the serving cell and the second RS is not associated with the serving cell. In an example, based on the first RS not being associated with the serving cell and the second RS not being associated with the serving cell, the one or more TCI states (used to receive/buffer the scheduled DL reception) may be determined based on the second TCI codepoint (with the lowest TCI codepoint index among the TCI codepoints, for example). For example, the UE may determine the third TCI state to be a TCI state of the second TCI codepoint (with the lowest TCI codepoint index). In an example, each TCI codepoint of the TCI codepoints (from which the second TCI codepoint is selected, for example) may comprise two TCI states (e.g., two DL/joint TCI states), wherein each TCI state of the two TCI states of the TCI codepoint is associated with a RS associated with the serving cell. Alternatively and/or additionally, each TCI codepoint of the TCI codepoints may comprise two TCI states (e.g., two DL/joint TCI states), wherein at least one TCI state of the two TCI states of the TCI codepoint is associated with a RS associated with the serving cell (e.g., one of the two TCI states may be associated with a RS that is not associated with the serving cell). In some examples, the one or more TCI states used to receive/buffer the scheduled DL reception are determined based on one or more TCI states (e.g., one or more DL/joint TCI states that are associated with RS associated with the serving cell) in the second TCI codepoint. For example, the one or more TCI states used to receive/buffer the scheduled DL reception may comprise the one or more TCI states (e.g., one or two DL/joint TCI states) in the second TCI codepoint.

In one example, the second PDCCH is received after the first timing, and/or the first TCI DL/joint TCI state and/or the second TCI DL/joint TCI state, indicated by the first PDCCH, are applied for at least one of the second PDCCH, the scheduled DL reception.

In one embodiment, the scheduled DL reception comprises a PDSCH (scheduled by the second PDCCH, for example) and/or a CSI-RS (scheduled and/or activated by the second PDCCH, for example).

Referring back to FIGS. 3 and 4, in one exemplary embodiment of a UE in a wireless communication system, the device 300 includes a program code 312 stored in the memory 310. The CPU 308 may execute program code 312 to enable the UE (i) to receive a first PDCCH indicating a first DL/joint TCI state, and a second DL/joint TCI state comprising at least one of a DL or joint TCI state, wherein the first DL/joint TCI state or the second DL/joint TCI state are configured to be applied for one or more receptions comprising one or more UE-dedicated DL receptions after a first time, (ii) to receive a second PDCCH, (iii) when a scheduling offset between the second PDCCH and a scheduled DL reception is smaller than a threshold, to determine a third TCI state to use for the scheduled DL reception based on whether or not a first RS associated with the first DL/joint TCI state is associated with a serving cell of the UE, and/or whether or not a second RS associated with the second TCI state is associated with the serving cell, and (iv) to receive/buffer the scheduled DL reception based on one or more TCI states comprising the third TCI state. Furthermore, the CPU 308 can execute the program code 312 to perform one, some and/or all of the above-described actions and steps and/or others described herein.

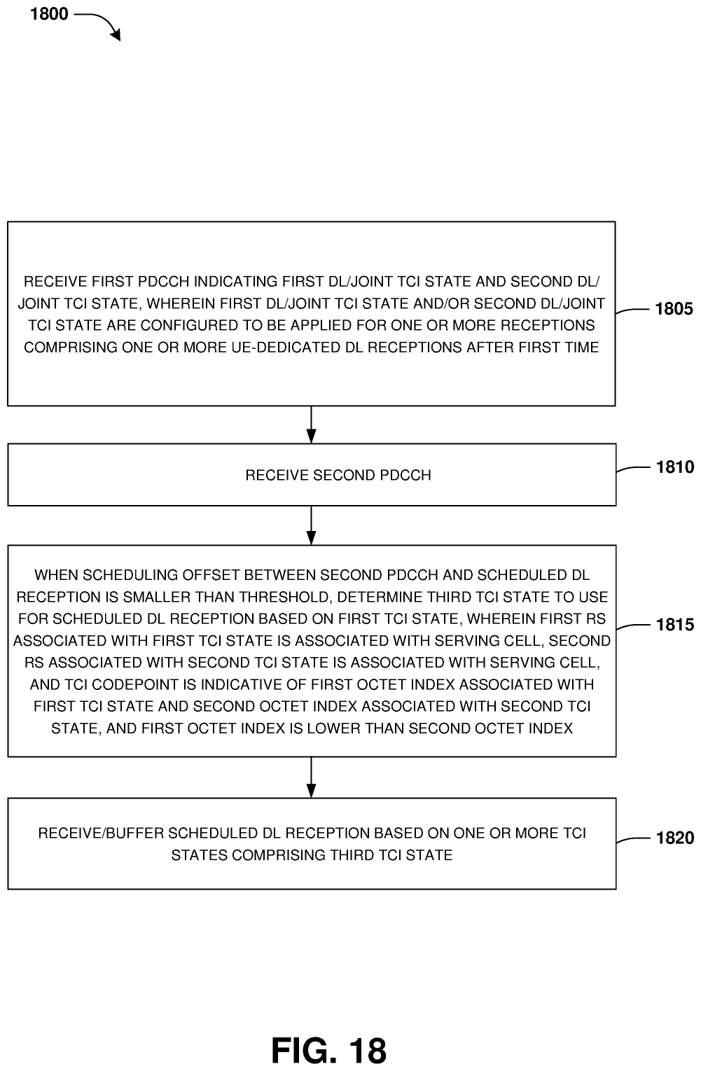

FIG. 18 is a flow chart 1800 according to one exemplary embodiment from the perspective of a UE in a wireless communication system. In step 1805, the UE receives a first PDCCH indicating a first DL/joint TCI state and a second DL/joint TCI state. The first DL/joint TCI state and/or the second DL/joint TCI state may be configured to be applied for one or more receptions comprising one or more UE-dedicated DL receptions (and/or one or more other receptions in addition to the one or more UE-dedicated DL receptions, for example) after a first time. For example, application of the first DL/joint TCI state and/or the second DL/joint TCI state may start from the first time (e.g., the first time may correspond to a start time for application of the first DL/joint TCI state and/or the second DL/joint TCI state to perform one or more receptions, such as the one or more UE-dedicated DL receptions). In step 1810, the UE receives a second PDCCH. In step 1815, when a scheduling offset between the second PDCCH and a scheduled DL reception is smaller than a threshold (e.g., the threshold may correspond to timedurationForQCL), the UE determines a third TCI state (e.g., a DL/joint TCI state) to use for the scheduled DL reception based on the first DL/joint TCI state. In an example, the UE determines the third TCI state to be the first DL/joint TCI state. In an example, the UE determines the third TCI state to be the DL/joint TCI state among the first DL/joint TCI state and the second DL/joint TCI state which is associated with lower octet index in a TCI codepoint. A first RS associated with the first DL/joint TCI state is associated with a serving cell (of the UE, for example). A second RS associated with the second DL/joint TCI state is associated with the serving cell. A TCI codepoint (with which the UE is configured, for example) is indicative of a first octet index associated with the first DL/joint TCI state and a second octet index associated with the second DL/joint TCI state. The first octet index associated with the first DL/joint TCI state is lower than the second octet index associated with the second DL/joint TCI state. In some examples, the third TCI state corresponds to a defined TCI state (e.g., a default and/or specific TCI state) used by the UE to receive the scheduled DL reception. In some examples, the scheduled DL reception comprises one or more DL transmissions (e.g., one or more DL channels and/or signals) from a network to the UE (e.g., the scheduled DL reception may comprise one or more slots and/or one or more symbols of the one or more DL transmissions by the network). In some examples, the scheduled DL reception (e.g., the one or more DL transmissions) is scheduled by the second PDCCH. In an example, the scheduled DL reception (e.g., the one or more DL transmissions) may comprise one or more PDSCHs (e.g., one or more scheduled PDSCHs). In step 1820, the UE receives/buffers the scheduled DL reception based on one or more TCI states comprising the third TCI state. For example, the one or more TCI states may be used by the network to transmit the one or more DL transmissions (e.g., the network may transmit the one or more DL transmissions using one or more beams corresponding to the one or more TCI states). The UE may use the one or more TCI states to receive/buffer the one or more DL transmissions (e.g., the UE may successfully receive the one or more DL transmissions using the one or more beams corresponding to the one or more TCI states). In some examples, the one or more TCI states corresponds to one or more defined TCI states (e.g., one or more default and/or specific TCI states) used by the UE to receive the scheduled DL reception.

In some examples, the UE determines the third TCI state based on the first DL/joint TCI state (e.g., the UE may determine the third TCI state to be the first DL/joint TCI state and/or the UE may use the first DL/joint TCI state to receive/buffer the one or more DL transmissions) based on (i) the first RS associated with the first DL/joint TCI state being associated with the serving cell, (ii) the second RS associated with the second DL/joint TCI state being associated with the serving cell, and/or (iii) the first octet index associated with the first DL/joint TCI state being lower than the second octet index associated with the second DL/joint TCI state.

In one embodiment, the UE does not support receiving a DL reception (e.g., a channel and/or a signal) based on two TCI states (e.g., the UE does not have capability and/or is not configured to receive a DL reception, such as the scheduled DL reception, using two TCI states).

In one embodiment, based on the UE supporting receiving a DL reception (e.g., a channel and/or a signal) based on two TCI states (e.g., the UE has capability and/or is configured to receive a DL reception, such as the scheduled DL reception, using two TCI states), the one or more TCI states used to receive/buffer the scheduled DL reception comprise two TCI states. For example, if the UE supports receiving a DL reception based on two TCI states, the one or more TCI states used to receive/buffer the scheduled DL reception may comprise two TCI states regardless of whether or not the scheduling offset is smaller than the threshold.

In one embodiment, the one or more TCI states used to receive/buffer the scheduled DL reception comprise the first DL/joint TCI state and the second DL/joint TCI state. For example, the third TCI state (of the one or more TCI states) may be determined to be the first DL/joint TCI state (and/or the second DL/joint TCI state may be included in the one or more TCI states). In some examples, the first DL/joint TCI state and the second DL/joint TCI state may be included in the one or more TCI states (used to receive/buffer the scheduled DL reception) based on (i) the first RS associated with the first DL/joint TCI state being associated with the serving cell, (ii) the second RS associated with the second DL/joint TCI state being associated with the serving cell, and/or (iii) the UE supporting receiving a DL reception (e.g., a channel and/or a signal) based on two TCI states.

In one example, the second PDCCH is received after the first timing, and/or the first TCI DL/joint TCI state and/or the second TCI DL/joint TCI state, indicated by the first PDCCH, are applied for at least one of the second PDCCH, the scheduled DL reception.

In one embodiment, the scheduled DL reception comprises a PDSCH (scheduled by the second PDCCH, for example) and/or a CSI-RS (scheduled and/or activated by the second PDCCH, for example).

In some examples, FIG. 18 may be supplemented with one, some and/or all of the techniques provided herein with respect to FIG. 17.

Referring back to FIGS. 3 and 4, in one exemplary embodiment of a UE in a wireless communication system, the device 300 includes a program code 312 stored in the memory 310. The CPU 308 may execute program code 312 to enable the UE (i) to receive a first PDCCH indicating a first DL/joint TCI state, and a second DL/joint TCI state comprising at least one of a DL or joint TCI state, wherein the first DL/joint TCI state or the second DL/joint TCI state are configured to be applied for one or more receptions comprising one or more UE-dedicated DL receptions after a first time, (ii) to receive a second PDCCH, (iii) when a scheduling offset between the second PDCCH and a scheduled DL reception is smaller than a threshold, to determine a third TCI state to use for the scheduled DL reception based on the first DL/joint TCI state, wherein a first RS associated with the first DL/joint TCI state is associated with a serving cell of the UE, wherein a second RS associated with the second DL/joint TCI state is associated with the serving cell, and wherein a first octet index, indicated by a TCI codepoint, associated with the first DL/joint TCI state is lower than a second octet index, indicated by the TCI codepoint, associated with the second DL/joint TCI state, and (iv) to receive/buffer the scheduled DL reception based on one or more TCI states comprising the third TCI state. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 14-18. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 14-18, and/or one, some and/or all of the above-described actions and steps and/or others described herein.

It may be appreciated that applying one or more of the techniques presented herein may result in one or more benefits including, but not limited to, increased efficiency of communication between devices (e.g., a UE and/or a network node), such as due, at least in part, to enabling the devices to (accurately) determine a defined (e.g., default) beam for receiving/buffering one or more PDSCHs (considering inter-cell cell mTRP, for example).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method for a User Equipment (UE), the method comprising:
receiving a first Physical Downlink Control Channel (PDCCH) indicating:
a first Transmission Configuration Indicator (TCI) state comprising at least one of a first downlink (DL) TCI state or a first joint TCI state; and
a second TCI state comprising at least one of a second DL TCI state or a second joint TCI state, wherein at least one of the first TCI state or the second TCI state is configured to be applied for one or more receptions comprising one or more UE-dedicated DL receptions after a first time;
receiving a second PDCCH;
when a scheduling offset between the second PDCCH and a scheduled DL reception is smaller than a threshold, determining a third TCI state to use for the scheduled DL reception based on at least one of:
whether or not a first reference signal (RS) associated with the first TCI state is associated with a serving cell of the UE; or
whether or not a second RS associated with the second TCI state is associated with the serving cell; and
at least one of receiving or buffering the scheduled DL reception based on one or more TCI states comprising the third TCI state.

2. The method of claim 1, wherein:
the UE does not support receiving a DL reception based on two TCI states.

3. The method of claim 1, wherein at least one of:
the first RS and the second RS are associated with quasi-colocation (QCL) type-D assumption;
the first RS is associated with a first cell or a second cell; or the second RS is associated with the first cell or the second cell.

4. The method of claim 1, wherein at least one of:
the serving cell is associated with a serving cell index; or
the serving cell is not associated with an index for configuring an additional Physical Cell Identity (PCI).

5. The method of claim 1, wherein at least one of:
at least one of the first RS or the second RS is associated with a second cell;
the second cell is not associated with a serving cell index;
the second cell is associated with an index for configuring an additional Physical Cell Identity (PCI);
the second cell is a non-serving cell; or
the second cell is an additional cell.

6. The method of claim 2, wherein:
the first RS is associated with the serving cell and the second RS is associated with the serving cell; and
the third TCI state is determined based on the first TCI state, wherein the first TCI state corresponds to at least one of a DL TCI state in a TCI codepoint or a joint TCI state in the TCI codepoint.

7. The method of claim 2, wherein:
the first RS is associated with the serving cell and the second RS is associated with the serving cell; and
the third TCI state is determined based on a TCI state, of the first TCI state and the second TCI state, that has a lowest TCI state identity (ID) among a first TCI state ID associated with the first TCI state and a second TCI state ID associated with the second TCI state.

8. The method of claim 2, wherein:
the first RS is associated with the serving cell and the second RS is associated with a second cell; and
the third TCI state is determined based on the first TCI state in response to the first RS being associated with the serving cell.

9. The method of claim 2, wherein:
the first RS is associated with the serving cell and the second RS is associated with a second cell; and
the third TCI state is determined based on a TCI state of a Control Resource Set (CORESET) with a lowest CORESET identity (ID) among one or more CORESET IDs of one or more CORESETs in one or more slots.

10. The method of claim 2, wherein:
the first RS is associated with a second cell and the second RS is associated with the second cell; and
the third TCI state is determined based on a TCI state in a TCI codepoint with a lowest TCI codepoint index among TCI codepoints comprising at least one TCI state that is associated with a RS associated with the serving cell and comprises at least one of a DL TCI state or a joint TCI state.

11. The method of claim 2, wherein:
the first RS is associated with a second cell and the second RS is associated with the second cell; and
the third TCI state is determined based on a TCI state of a Control Resource Set (CORESET) with a lowest CORESET identity (ID) among one or more CORESET IDs of one or more CORESETs in one or more slots.

12. The method of claim 1, wherein:
based on the UE supporting receiving a DL reception based on two TCI states, the one or more TCI states used to at least one of receive or buffer the scheduled DL reception comprise two TCI states.

13. The method of claim 12, wherein:
the one or more TCI states used to at least one of receive or buffer the scheduled DL reception comprise the first TCI state and the second TCI state; and
at least one of the first RS or the second RS is associated with the serving cell.

14. The method of claim 12, wherein:
the one or more TCI states used to at least one of receive or buffer the scheduled DL reception are determined based on a TCI codepoint with a lowest TCI codepoint index among TCI codepoints comprising two TCI states associated with a RS associated with the serving cell; and
the first RS is not associated with the serving cell and the second RS is not associated with the serving cell.

15. The method of claim 1, wherein the scheduled DL reception comprises at least one of:
a Physical Downlink Shared Channel (PDSCH) scheduled by the second PDCCH; or a Channel State Information Reference Signal (CSI-RS) at least one of scheduled or activated by the second PDCCH.

16. A method for a User Equipment (UE), the method comprising:
receiving a first Physical Downlink Control Channel (PDCCH) indicating:
a first Transmission Configuration Indicator (TCI) state comprising at least one of a first downlink (DL) TCI state or a first joint TCI state; and
a second TCI state comprising at least one of a second DL TCI state or a second joint TCI state, wherein at least one of the first TCI state or the second TCI state is configured to be applied for one or more receptions comprising one or more UE-dedicated DL receptions after a first time;
receiving a second PDCCH;
when a scheduling offset between the second PDCCH and a scheduled DL reception is smaller than a threshold, determining a third TCI state to use for the scheduled DL reception based on the first TCI state, wherein:
a first reference signal (RS) associated with the first TCI state is associated with a serving cell;
a second RS associated with the second TCI state is associated with the serving cell;
a TCI codepoint is indicative of a first octet index associated with the first TCI state and a second octet index associated with the second TCI state; and
the first octet index is lower than the second octet index; and
at least one of receiving or buffering the scheduled DL reception based on one or more TCI states comprising the third TCI state.

17. The method of claim 16, wherein:
the UE does not support receiving a DL reception based on two TCI states, and/or
the UE determines the third TCI state to be the first DL/joint TCI state.

18. The method of claim 16, wherein:
based on the UE supporting receiving a DL reception based on two TCI states, the one or more TCI states used to at least one of receive or buffer the scheduled DL reception comprise two TCI states.

19. The method of claim 18, wherein:
the one or more TCI states used to at least one of receive or buffer the scheduled DL reception comprise the first TCI state and the second TCI state.

20. The method of claim 16, wherein the scheduled DL reception comprises at least one of:
a Physical Downlink Shared Channel (PDSCH) scheduled by the second PDCCH; or
a Channel State Information Reference Signal (CSI-RS) at least one of scheduled or activated by the second PDCCH.
